(19) United States
(12) Patent Application Publication
(10) Pub. No.: US 2025/0166328 A1
(43) Pub. Date: May 22, 2025

(54) EXTENDED REALITY AUTHORING SYSTEM AND METHOD

(71) Applicant: Beamm Technologies Inc., Wilmington, DE (US)

(72) Inventors: Daverin Nadesan, Wilmington, DE (US); Divesh Naidoo, Wilmington, DE (US)

(73) Assignee: Beamm Technologies Inc., Wilmington, DE (US)

(21) Appl. No.: 18/954,183

(22) Filed: Nov. 20, 2024

Related U.S. Application Data
(60) Provisional application No. 63/601,023, filed on Nov. 20, 2023.
(60) Provisional application No. 63/640,433, filed on Apr. 30, 2024.

(51) Int. Cl. G06T 19/20; G06T 5/60; G06T 5/92; G06T 15/04; G06T 15/50

(52) U.S. Cl. CPC G06T 19/20; G06T 5/60; G06T 5/92; G06T 15/04; G06T 15/506; G06T 2207/20081; G06T 2207/20208; G06T 2210/08

(57) ABSTRACT

In variants, the method can include: displaying a low-fidelity version of an asset in an extended-reality (XR) interface on an authoring device; receiving transformations of the low-fidelity asset from the user; and rendering high fidelity content using the transformations and a high-fidelity version of the asset. In variants, the method can also include: sampling LDR data using a mobile device, generating HDR data from the LDR data at a remote computing system, convolving the HDR data into a set of preconvolved HDR maps at the remote computing system, sending the set of preconvolved HDR maps to the mobile device, and dynamically rendering an XR asset at the mobile device by sampling a preconvolved HDR map associated with a surface parameter of the asset.

### CROSS-REFERENCE TO RELATED APPLICATIONS

This application claims the benefit of U.S. Provisional Application No. 63/601,023 filed Nov. 20, 2023 and U.S. Provisional Application No. 63/640,433 filed Apr. 30, 2024, each of which are incorporated in their entireties by this reference.

### TECHNICAL FIELD

This invention relates generally to the extended reality field, and more specifically to a new and useful high fidelity extended reality authoring system and method in the extended reality field.

### BRIEF DESCRIPTION OF THE FIGURES

FIG. 1 is a schematic representation of a variant of the method.

FIG. 2 is a schematic representation of data flow between entities in a variant of the method.

FIG. 3 is a schematic representation of a variant of modifying pre-generated content and a variant of displaying pre-generated content.

FIGS. 4A-4J is an illustrative example of initializing a scene.

FIGS. 5A-5M is an illustrative example of authoring content on a mobile device (e.g., S100-S400).

FIGS. 6A-6Q is an illustrative example of modifying the content on a secondary computing device and rendering high-fidelity content (e.g., S200-S500).

FIGS. 7A-7I is an illustrative example of displaying generated content in the scene.

FIG. 8 is a schematic representation of an example asset with associated variants.

FIG. 9 is a schematic representation of an example composable.

### DETAILED DESCRIPTION

The following description of the embodiments of the invention is not intended to limit the invention to these embodiments, but rather to enable any person skilled in the art to make and use this invention.

### 1. Overview

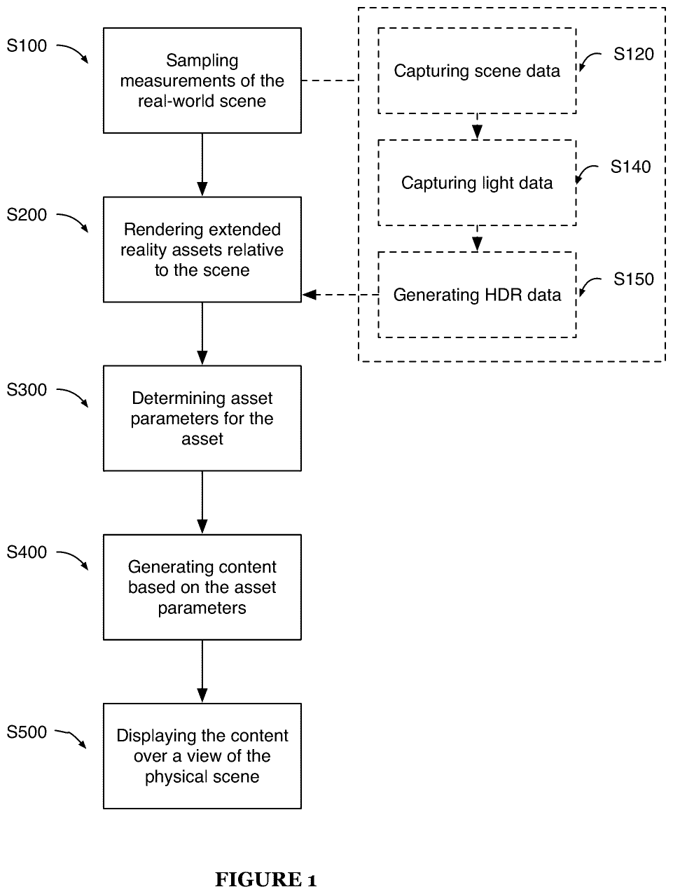

As shown in FIG. 1, in variants, the method can include: sampling measurements of the real-world scene S100; rendering extended reality assets relative to the scene S200; determining asset parameters for the asset S300; generating content based on the asset parameters S400; and displaying the content over a view of the physical scene S500. The method can function to generate high-fidelity extended-reality (XR) content using low-quality data authored on a mobile device.

### 2. Examples

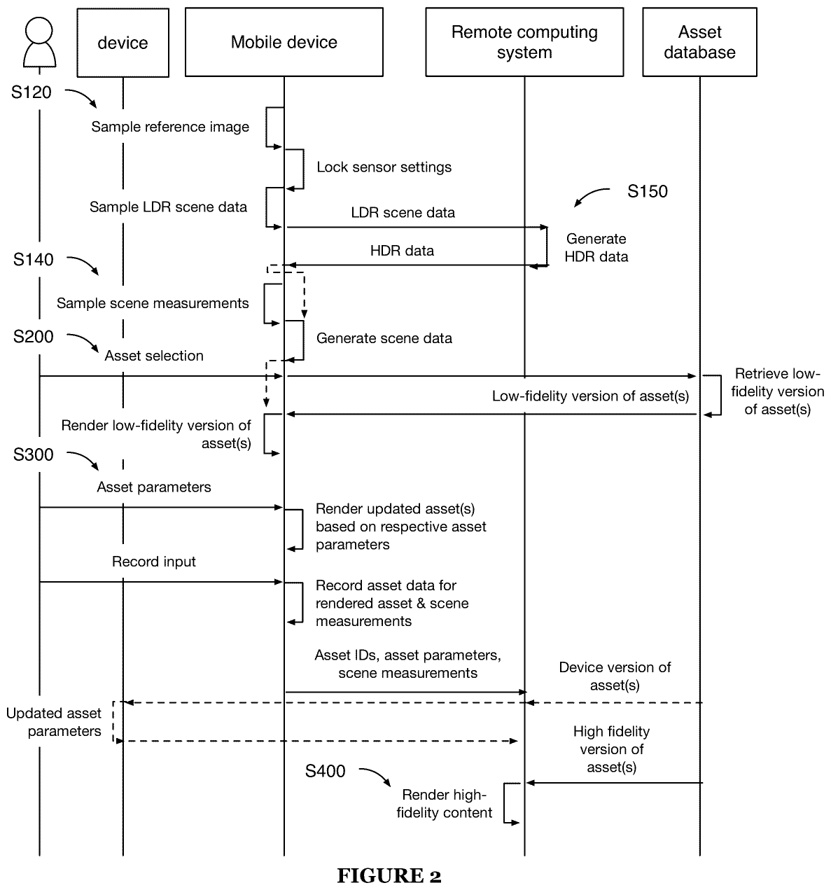

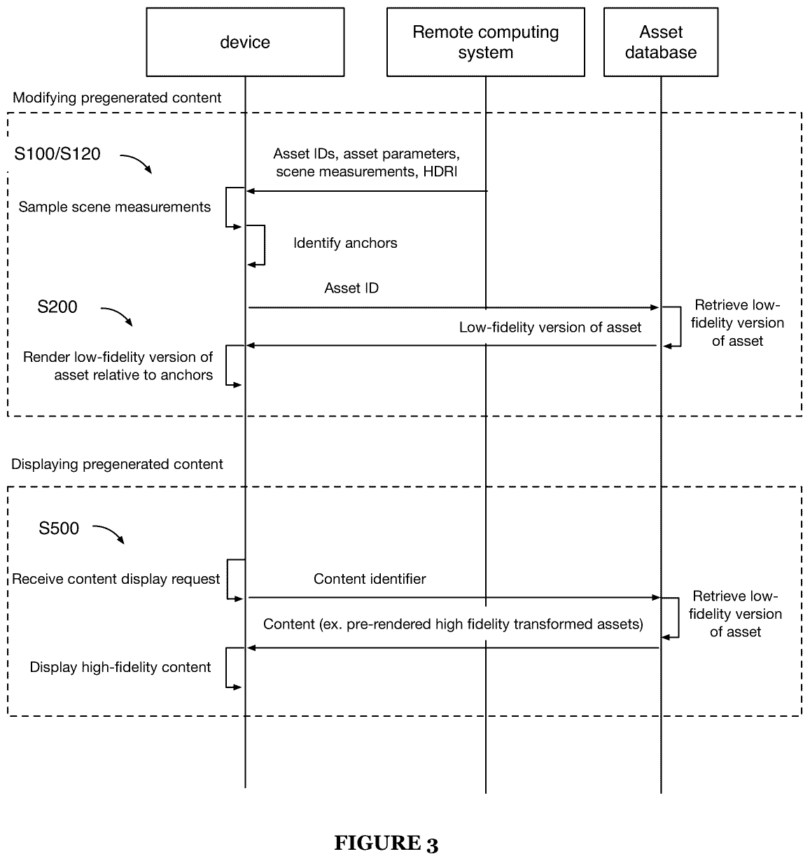

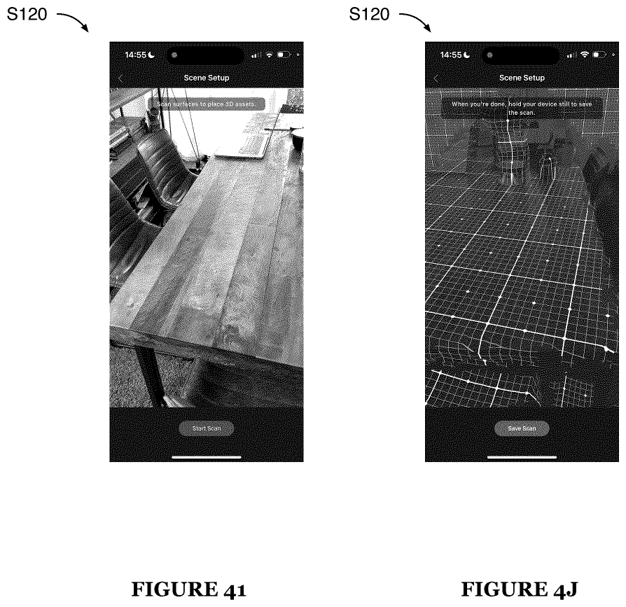

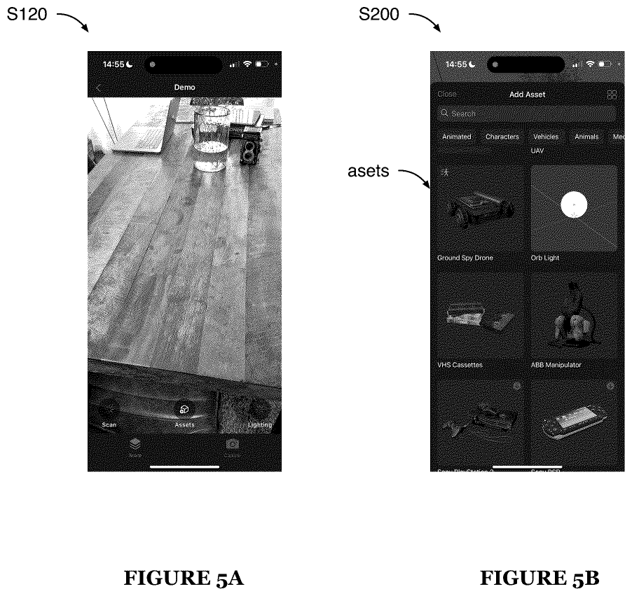

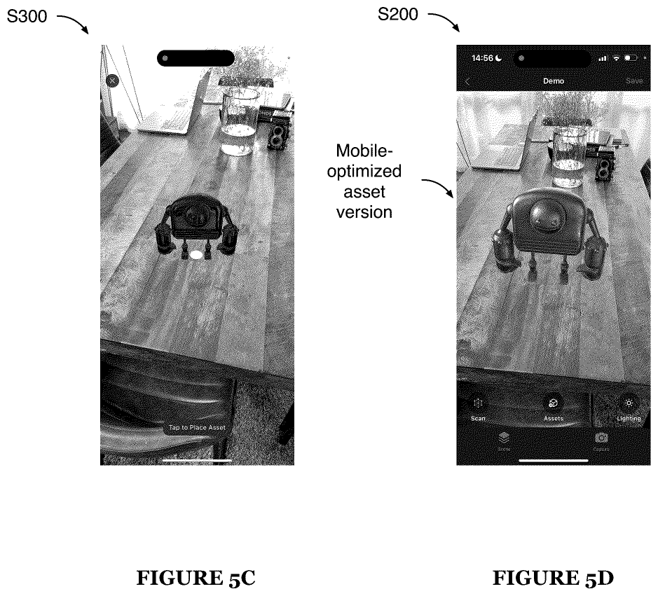

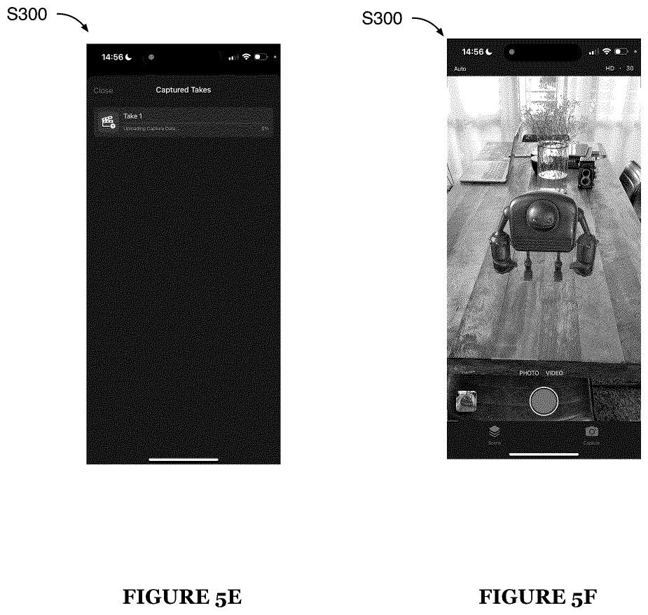

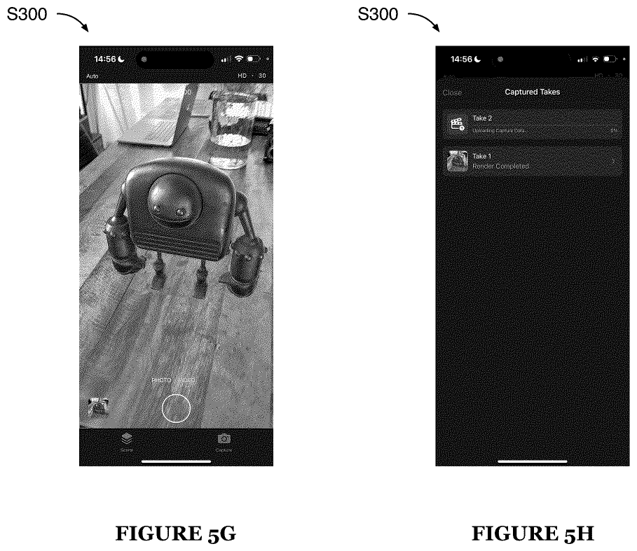

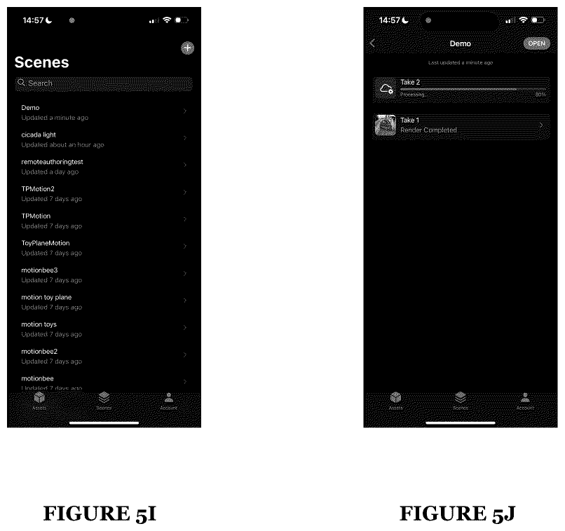

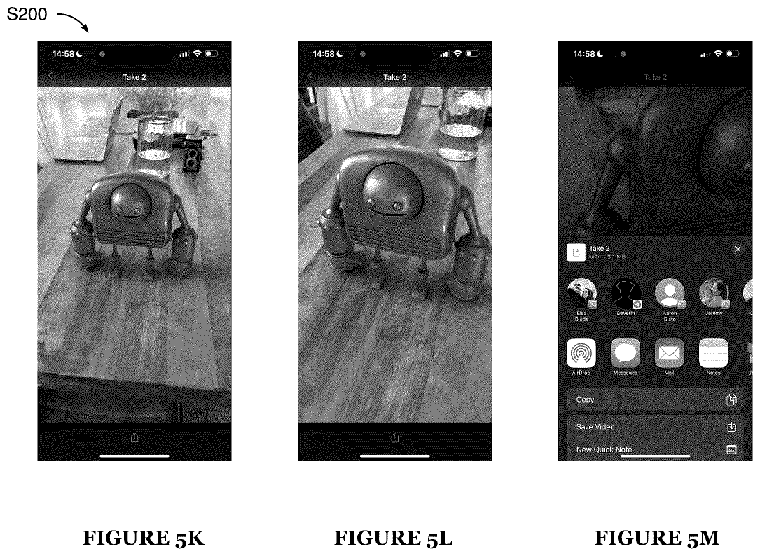

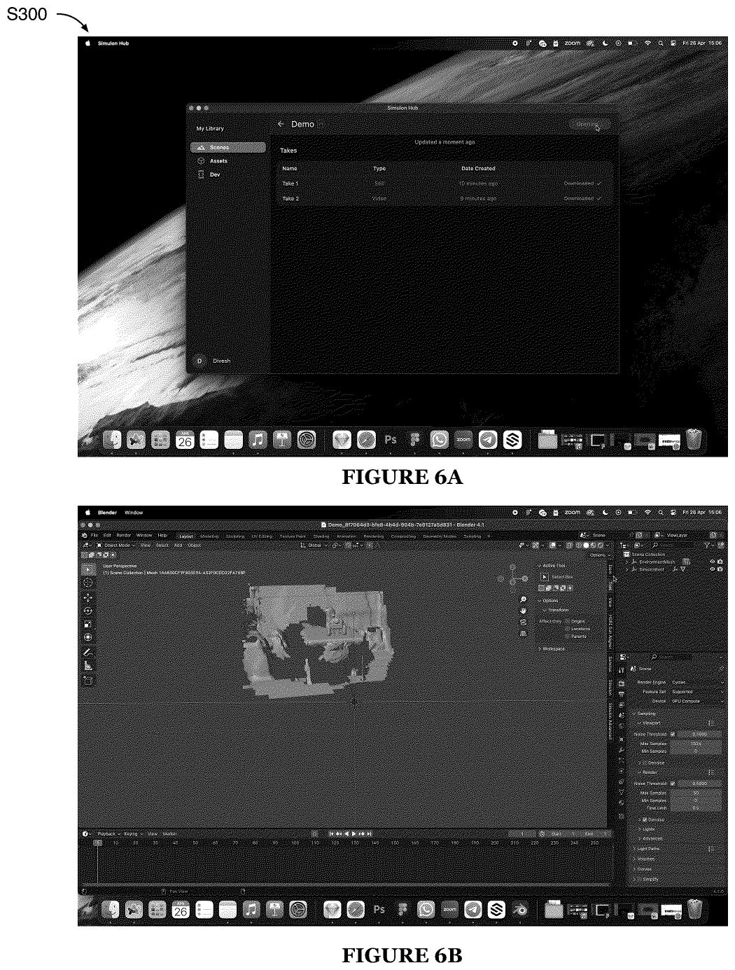

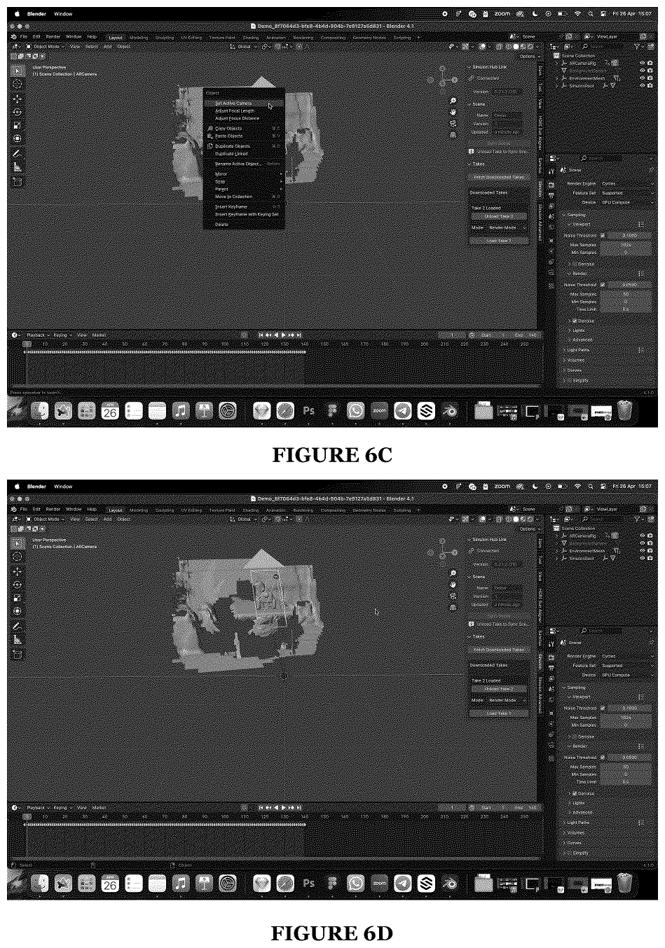

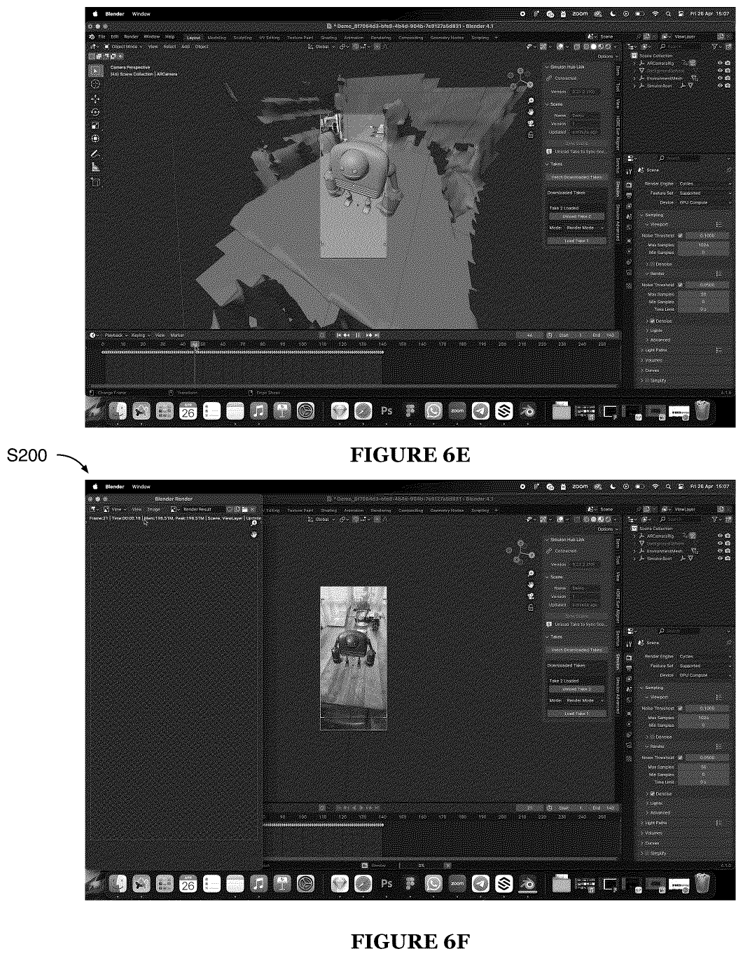

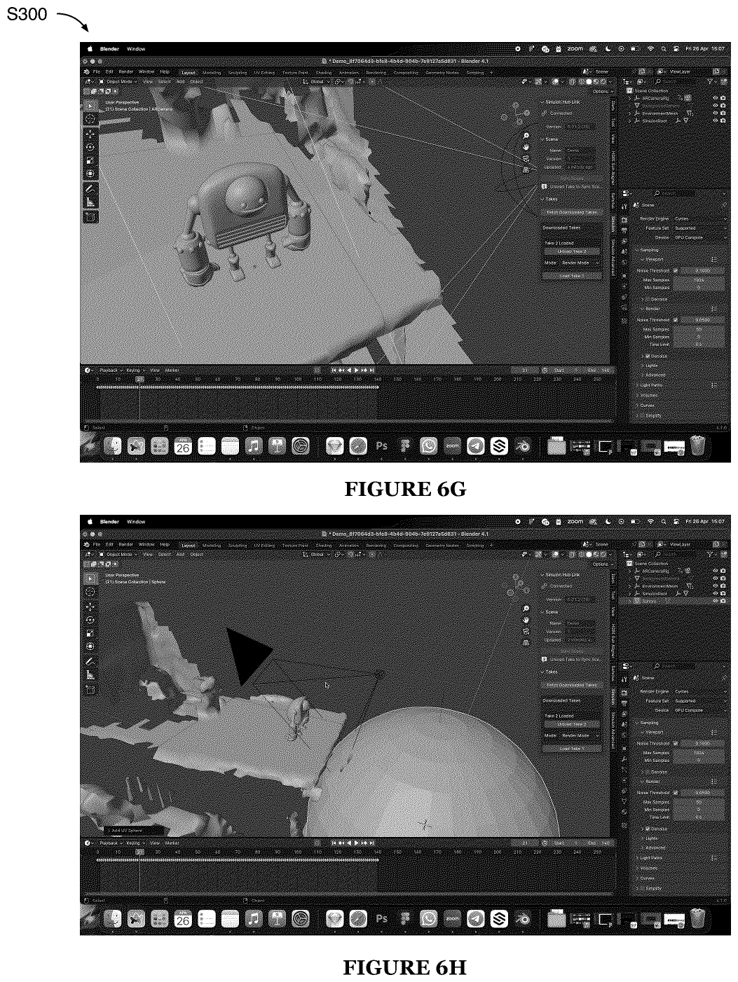

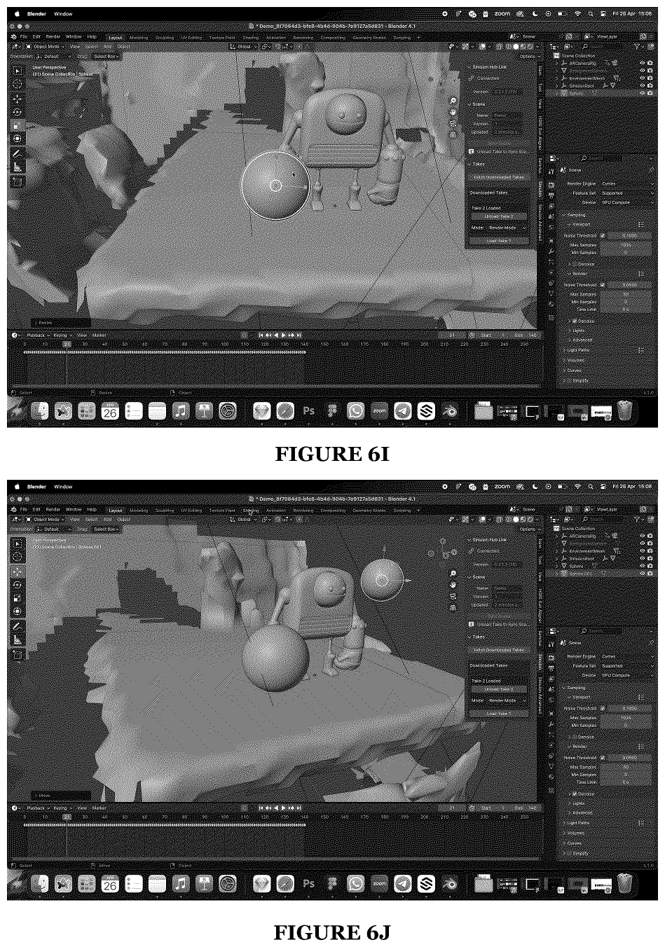

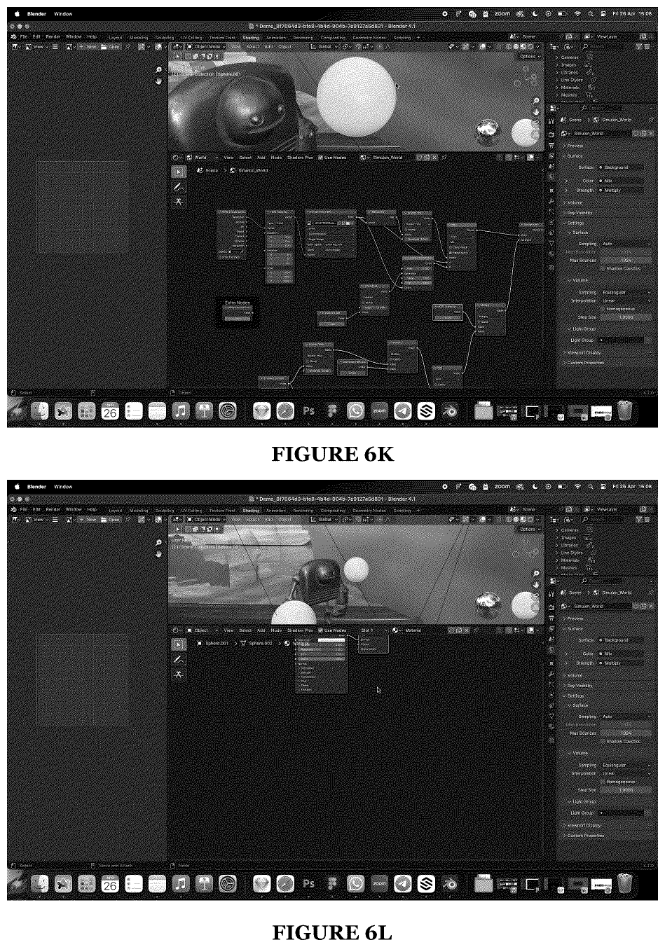

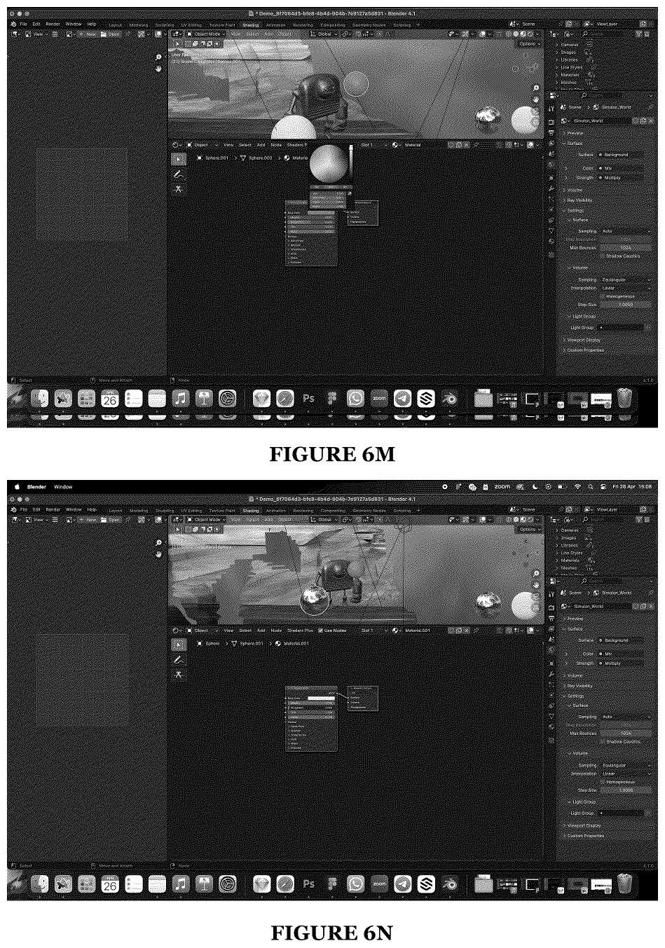

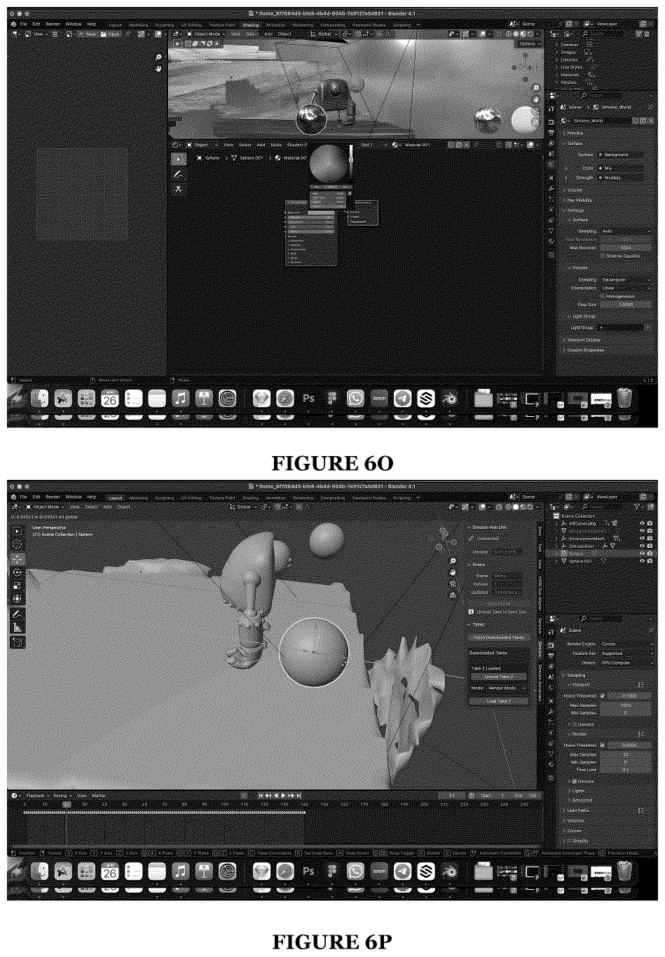

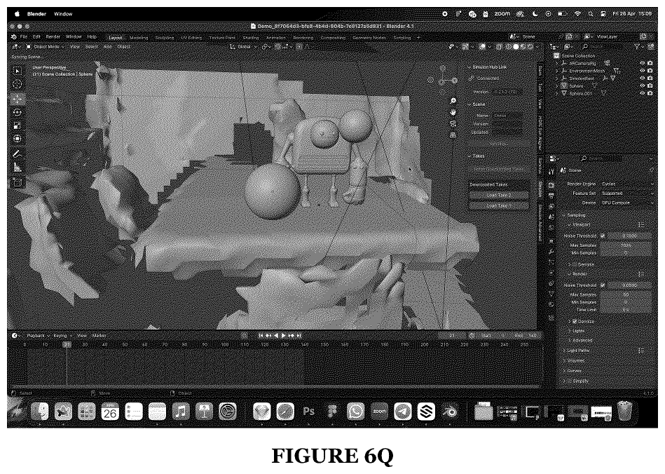

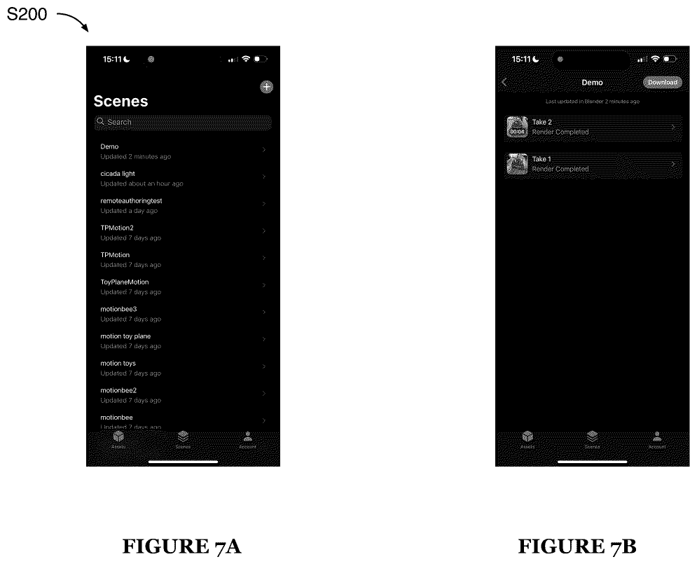

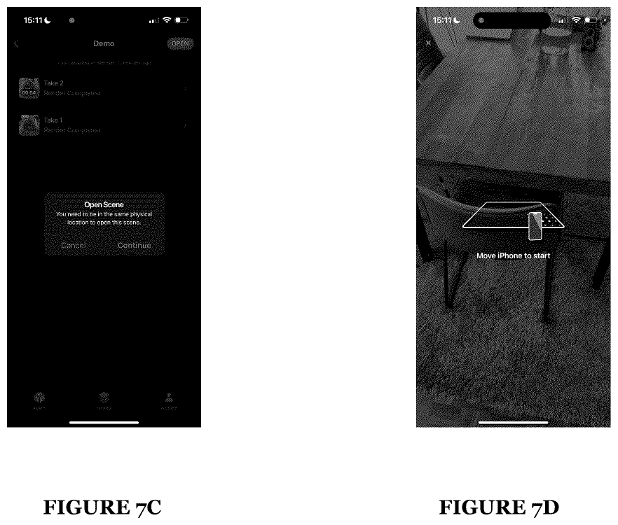

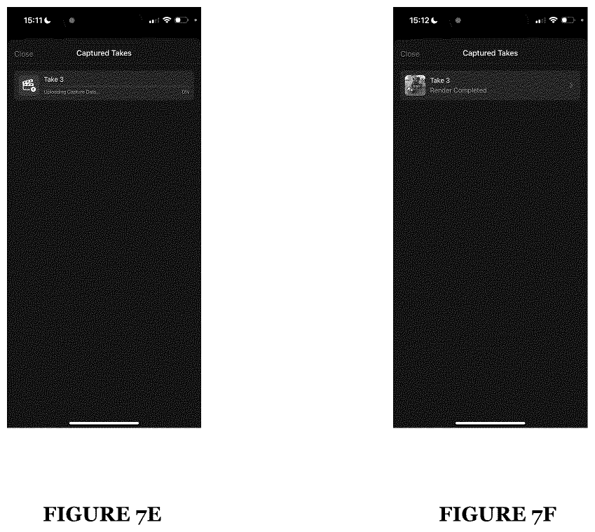

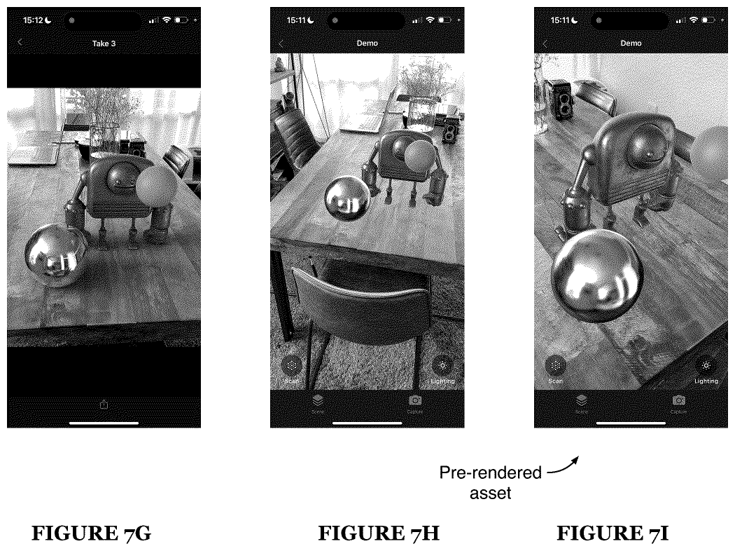

In an example, the method can include: displaying a mobile version of an asset in an extended-reality (XR) interface on an authoring device (e.g., a mobile device); receiving transformations of the asset (e.g., asset parameters) from the user; and rendering high fidelity content using the transformations and a high-fidelity version of the asset (e.g., higher fidelity than the mobile version). In an illustrative example, the method can include: at a mobile device: sampling a set of measurements of a physical scene; receiving a digital asset selection; rendering a mobile-optimized version of the digital asset relative to the scene (e.g., using AR or VR techniques); receiving a set of asset parameters for the asset from a user; modifying the displayed digital asset based on the set of asset parameters (e.g., rendering the asset with the asset parameters in real-time); in response to receiving a recording input from the user, recording a video of the physical scene, recording the asset identifier and the set of asset parameters, and optionally recording the modified digital asset; and sending the asset identifier, the set of asset parameters, and the video of the physical scene to a remote rendering service. The remote rendering service can receive the asset identifier, the set of asset parameters, and the video of the physical scene; and render a higher-quality version of the recording by: retrieving a higher-quality version of the digital asset; modifying the higher-quality version of the digital asset based on the set of asset parameters; and rendering the modified higher-quality version of the digital asset over the video of the scene (e.g., using the transformations specified in the set of asset parameters). Examples of the workflow are shown in FIG. 2, FIGS. 5A-5M (e.g., recording content information), and FIGS. 6A-6Q (e.g., post-recording editing). All or portions of the resultant content (e.g., only the modified higher-quality assets) can be played on a content platform, replayed when a user plays the content within the physical scene, edited (e.g., by changing the asset parameters, etc.), and/or otherwise used. For example, the resultant content, including the transformed high-fidelity assets (e.g., prerendered high-fidelity assets), scene references (e.g., scene anchors), and optionally the scene views, can be sent to secondary devices for playback and/or modification. Examples are shown in FIG. 3 and FIGS. 7A-7I (e.g., displaying the high-fidelity transformed asset).

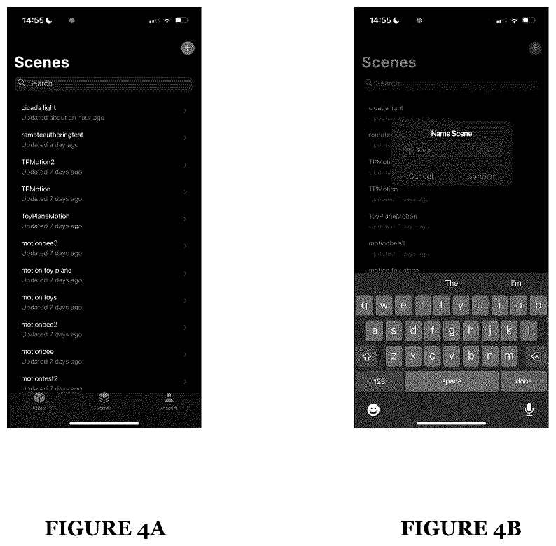

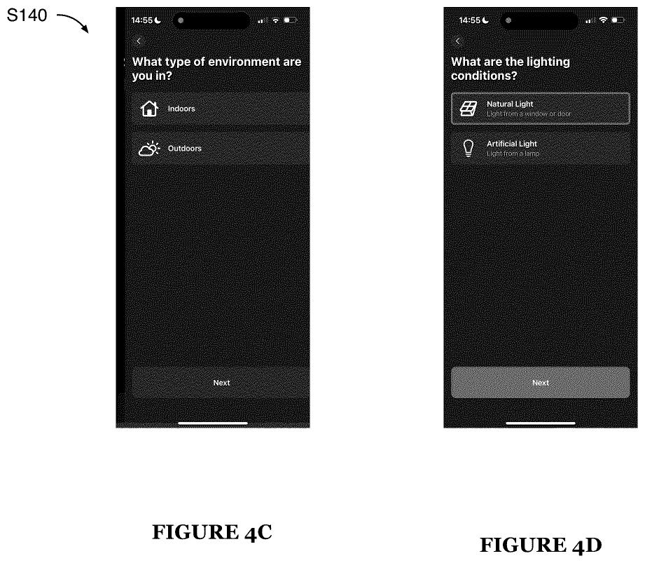

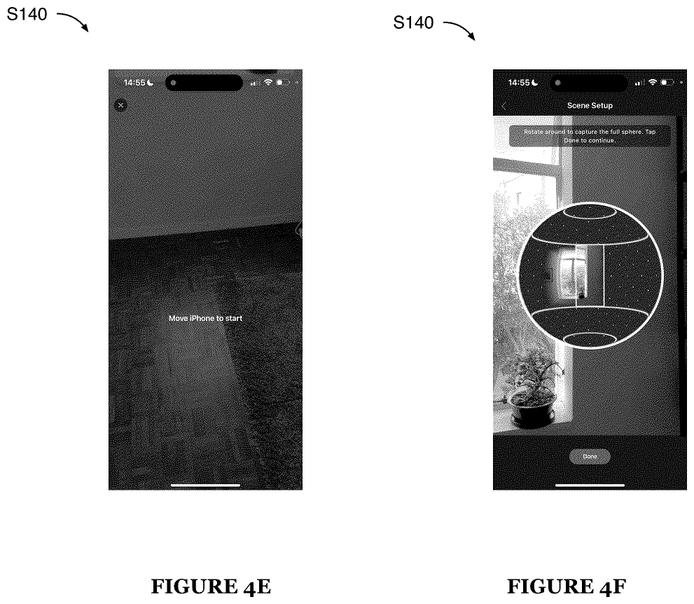

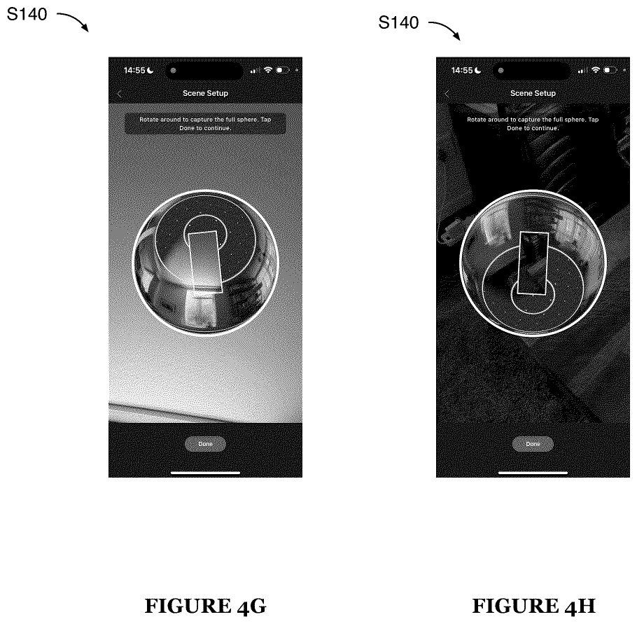

In examples, the method can optionally include initializing the scene using the set of physical measurements, including: determining light data and determining scene geometry data. In variants, determining light data can include determining HDR data (e.g., a set of HDR environment maps) for the scene by: sampling an image of a collectively-illuminated region of the scene (e.g., the floor); locking the camera settings used to sample the image (e.g., to establish a fixed 0-1 exposure range); sampling LDR data of the scene (e.g., an LDR environment map, an LDR image, a panorama, etc.) using the locked camera settings; optionally determining a scene classification (e.g., indoor/outdoor, natural/artificial light, etc.); and generating HDR data from the LDR data and optionally the camera settings (e.g., using inverse tone mapping, by running the LDR data through a machine learning model, etc.) and/or the scene classification (e.g., by applying a predetermined set of filters and/or applying a predetermined set of rules specific to each scene classification permutation). In variants, the LDR data is sampled at the mobile device, and a remote computing system determines the HDR data set (e.g., in real- or near-real time). An example workflow is shown in FIGS. 4A-4J. The remote computing system can optionally send the HDR data or alternative formats (e.g., diffuse irradiance, specular pre-convolved environment cubemaps, pre-convolved HDR environment maps, prefilters, etc.) back to the mobile device, where the mobile device can use the HDR data to dynamically render the mobile-optimized version of the digital asset (e.g., use a high resolution HDR datum to render a reflective surface of the asset, use a low resolution HDR datum to render a diffuse surface of the asset, etc.). In variants, the HDR datum can also be used to render the higher-quality version of the digital asset. For example, the HDR data generated from the LDR data (e.g., HDR environment map, HDR image set, etc.) can be pre-filtered using HDR convolution to generate a set of HDR prefilters (e.g., pre-convolved HDR environment maps, HDR environment maps or images at different resolutions, blur, sharpness, etc.), wherein different HDR prefilters are dynamically selected by the mobile device to render different components of a given asset, based on the component's surface roughness.

However, the method can be otherwise performed.

### 3. Technical Advantages

Variants of the technology can confer one or more advantages over conventional technologies.

First, variants of the method can leverage a library of digital extended reality assets, storing different versions of each asset. In operation, a display device can retrieve and render the variants of the asset that is optimal for the display device. While these asset versions may be lower fidelity (e.g., lower resolution, higher compression, etc.), this allows for lower bandwidth consumption and faster rendering on the display device.

Second, variants of the technology can store the authored content as a set of asset identifiers, associated asset parameters (e.g., transformations, metadata, etc.), and optionally scene information (e.g., anchor points, images, geometries, etc.). In specific examples, the authored content object can exclude the asset appearance as rendered on the display device (authoring device). This reduced content object (e.g., a Composable) can require less memory to store, less bandwidth to transfer, and be more extensible to different post-processing platforms (e.g., Blender), while enabling the technology to generate high-fidelity versions of the authored content. The reduced content object can also enable the technology to implement characteristics of a real-time game engine while creating cinematic quality content (e.g., using an offline rendering system). In an example, in operation, the rendering system (e.g., rendering engine) can retrieve a high-fidelity version of each asset, transform the high-fidelity version of the asset using the respective asset parameters, and render the transformed high-fidelity version of the asset over the scene data (e.g., the sampled images or a rendered or augmented version thereof).

Third, variants of the method can generate HDR data for a scene in real-time, based on LDR data captured from the scene. In examples, this can be accomplished by capturing the LDR data using a set of locked camera settings, which sets a common 0-1 LDR range for the entirety of the LDR data capture, and provides a consistent baseline for subsequent HDR generation (e.g., which reduces or eliminates the need to correct for different auto-adjusted camera settings between different LDR frames, and therefore speeds up HDR generation). The inventors have discovered that locking the camera settings to the camera settings automatically determined by the camera when imaging a scene region illuminated by multiple light sources (e.g., a ground or floor, a table, etc.) can set the LDR range to a range that encompasses a vast majority of the lighting in the scene.

Fourth, variants of the method can bypass the limitations of path tracing (e.g., offline rendering) and rasterization (e.g., real-time rendering) by leveraging machine learning and cloud processing to overcome these limitations and combine the strengths of both approaches. In an example, a single LDR (Low Dynamic Range) capture is processed in the cloud using machine learning (and/or path tracing) to generate an HDR environment map. This HDR map is then convolved in the cloud (e.g., with another micro service) to produce multiple convolved maps (e.g., blurred versions) that represent lighting effects for various material types. These pre-convolved maps are transmitted back to the user's device, enabling real-time rendering of 3D objects with lighting and camera response closely approximating the final output (e.g., wherein the user's device samples the appropriate pre-convolved map based on a surface's roughness, providing a quick way to simulate realistic lighting on mobile in real-time). This makes reflections, ambient lighting, and materials appear more physically accurate in real time, without the need for the intensive path tracing calculations. This also enables users to have a relatively accurate representation of the lighting for their render, allowing them to preview and control dynamic camera settings like exposure and white balance with real-time feedback.

However, further advantages can be provided by the system and method disclosed herein.

### 4. System

All or portions of the method can be performed on a mobile device, a remote computing system, and/or any other device. The method can also be used with a scene.

The mobile device functions to provide an extended reality (XR) authoring and recordation interface. In variants, the mobile device renders real-time previews of an XR scene using mobile-optimized assets, records XR scenes using the mobile-optimized assets, and/or perform other functionalities. For example, the mobile device can capture scene data such as images, depth measurements, and light data, in addition to asset, such as the asset identifier and associated asset parameters (e.g., transformations, pose, visual parameters, etc.).

The method can be used with one or more mobile devices. Examples of mobile devices that can be used can include smartphones, tablets, laptops, wearable devices (e.g., smart glasses, augmented reality headsets, VR headsets, etc.), handheld gaming consoles, and/or other portable computing devices.

The mobile device can include a processing system, memory, communications module, and sensors. The processing system can include a CPU, GPU, IPU, and/or any other suitable processing units. The memory can include persistent memory, volatile memory, and/or any other suitable memory types. The communications module can include wireless communication, such as WiFi, cellular, Bluetooth, and/or any other suitable wireless protocols, as well as wired connections, such as Ethernet, USB, and/or any other suitable wired connections. The sensors can include optical sensors (e.g., cameras), audio sensors, speakers, visual displays, kinematic sensors (e.g., accelerometers, gyroscopes, IMU, etc.), geolocation sensors (e.g., GPS, odometry, etc.), depth sensors (e.g., projected light, LIDAR, etc.), and/or any other suitable sensors.

However, the mobile device may be otherwise configured.

The remote computing system functions to store assets and scenes. In variants, the remote computing system can: generate the HDR data, render high-fidelity content using captured scene data and asset data, store the assets, store generated content (e.g., scene data and associated asset data, such as asset identifiers and asset parameters), and/or perform other functionalities. In variants, the generated content can be stored using a custom data object (e.g., composables), a hierarchical data object (e.g., wherein different hierarchical levels store different types of data, such as asset identifier, scene pose, scale, asset parameters, etc.), and/or otherwise stored. Examples of remote computing system can include: a cloud computing system, a desktop system, a secondary mobile system, a distributed system (e.g., distributed storage system, blockchain system, etc.), and/or any suitable system. The remote computing system preferably has higher computing capabilities than the mobile device, but can additionally and/or alternatively have less computing capabilities.

However, remote computing system may be otherwise configured.

The scene functions to provide a physical environment for capturing and rendering extended reality (XR) content. The scene is preferably be a physical scene (e.g., real-world scene). The scene can include geometries, visual appearance (e.g., RGB values, NIR values, etc.), physical objects (e.g., stationary or mobile objects; walls, floor, tables, chairs, etc.), and/or other physical elements.

The scene can be indoor or outdoor. The scene can be naturally lit, artificially lit, or a combination thereof.

In variants, the scene can define anchor points. The anchor points can be tracked, used as reference points for XR asset transformation, and/or used to reanchor the content to the scene. The anchor points can include one or more: unique visual features (e.g., visual keypoints), unique geometric features (e.g., geometric keypoints), explicit anchor points (e.g., a visual code, such as QR code), and/or any suitable anchor points.

However, scene may be otherwise configured.

The method can be performed with one or more authoring sessions, during which a user authors XR content. An authoring session can include all or portions of: initializing the scene (e.g., using S120, S140, S150); iteratively determining the XR assets to render and/or asset parameters for each of the XR assets (e.g., S300, by reloading previously-determined content, etc.) and rendering the XR assets over views of the scene (e.g., S200), based on the asset parameters and optionally using the HDR data (e.g., generated in S150); and recording the content (e.g., saving the scene data and the asset data, including the asset identifiers and associated asset parameters, etc.). An authoring session can be specific to a scene or be associated with multiple scenes. However, the authoring session can be otherwise defined. The authoring session is preferably performed using the mobile application, but can alternatively be performed using the remote application (e.g., wherein scene initialization and/or scene data captured by the mobile application can be used during content authoring) and/or by any other suitable application.

In variants, the method can be performed using a platform including a mobile application; a remote application; an HDR data generation module; a high-fidelity rendering service (e.g., rendering module); and a set of assets.

The mobile application functions as a content authoring user interface. The mobile application can capture scene data (e.g., LDR data, scene geometry data, scene visual appearance data, etc.), and/or any suitable scene data. The mobile application can enable content authoring, which can include asset selection, asset placement, asset parameter selection, scene data capture, real-time asset rendering over a view of the scene, scene transmission to the remote applications, and/or other authoring functions. In variants, the mobile application can enable or perform all or portions of the method (e.g., perform or enable S100-S500; S100-S400; S100-S300; S120, S140, S150, S200, and S300; etc.). The mobile application can run on the mobile device, or on any other suitable device. However, the mobile application may be otherwise configured.

The remote application functions to provide a more featureful, higher-fidelity content authoring interface. The remote application can enable a user to add and/or remove assets, change asset parameters, change the scene data (e.g., remove depictions of physical objects in the physical scene, change the scene geometry, etc.), and/or enable other functionalities. The remote application can be a native desktop application or a browser-based application. The remote application can run on the remote computing system, on a computer (e.g., desktop, laptop, etc.), and/or on any other suitable system. However, the remote application may be otherwise configured.

The HDR data generation module functions to determine HDR data (e.g., perform S150) to enable XR assets to be correctly lit for the scene (e.g., that the mobile device is in). For example, the HDR data can include HDR environment maps, images, cube maps, convolution maps, and/or any suitable HDR data. New HDR data can be generated for each authoring session (e.g., generated based on new LDR data captured at the beginning of the authoring session), wherein the assets within each session are rendered using the new HDR data. Alternatively, HDR data from a prior authoring session can be used in subsequent authoring sessions. The system can include one or more HDR data generation modules. An HDR data generation module can perform inverse tone mapping, local contrast enhancement, exposure stacking, inpainting and extrapolation, histogram expansion, gaussian pyramids, simulated exposure fusion, multi-exposure bracketing (capturing multiple exposures and merging), machine learning-based HDR reconstruction (e.g., using a DNN, CNN, transformer, generative model, etc.; trained on LDR-HDR pairs, etc.), physical-based light modeling and estimation, hybrid approaches combining multiple techniques, and/or any suitable HDR data generation techniques. In an illustrative example, the HDR data generation module can include a machine learning model trained to predict an HDR environment map based on LDR data (e.g., trained on LDR inputs and HDR targets). However, the HDR data generation module can be otherwise generated. The HDR data generation module preferably runs on the remote computing system, but can alternatively run on a computer (e.g., laptop, desktop, etc.), and/or any other suitable computing system. However, HDR data generation module may be otherwise configured.

The high fidelity rendering service (e.g., rendering module) functions to render high-fidelity XR content. In an example, the high fidelity rendering service can render high fidelity versions of the XR assets using the respective asset parameters, then composite the XR assets with the scene data (e.g., real footage of the scene, augmented versions of the scene, synthesized scenes, etc.). The cinematic rendering service can generate the high fidelity content using the scene data, high-fidelity versions of the assets and asset parameters, optionally the HDR data generated by the HDR data generation module, and/or other data. The cinematic rendering service can use: ray tracing, global illumination, physically-based rendering, ambient occlusion, volumetric lighting, particle systems, tessellation, displacement mapping, subsurface scattering, motion blur, depth of field, anti-aliasing, and/or any other suitable rendering techniques to generate the content (e.g., render the high fidelity XR assets and/or composite the XR assets with the scene data). In variants, the cinematic rendering service can include a rendering engine, a compositing module, a lighting module, a texture mapping module, and/or any other suitable components.

However, the cinematic rendering service (e.g., rendering module) may be otherwise configured.

The asset functions to digitally augment a view or recording of a real-world scene. The asset can be used to add computer generated assets, add special effects, animate physical objects in the real-world scene, and/or otherwise used. The method can be used with one or more assets. Assets are preferably digital (e.g., computer generated), but can additionally or alternatively be digital representations of physical objects (e.g., objects in the scene, etc.), and/or otherwise represented. The asset can be 2D, 3D, 4D (e.g., an animation, etc.), and/or have any other suitable dimensionality.

The asset (and/or associated asset information) can be manually determined (e.g., composed by a user), automatically determined, and/or otherwise determined. For example, the asset can be automatically generated by simulating an object detected within the scene (e.g., using the object geometry and visual appearance from the scene measurements, etc.) and optionally automatically associating a predetermined set of attribute parameters to the object (e.g., based on the object classification; a predetermined set of animations, physics models, etc.). In another example, the asset can be automatically generated by simulating asset motion using the set of physics models. The asset can be generated de novo (e.g., without any priors), generated from a prior version of the asset (e.g., wherein the system can track a hierarchy of different versions of the asset), and/or otherwise generated.

Each asset can be associated with an asset identifier, a set of asset attributes, a set of available asset parameters, a set of asset versions for the asset, and/or other information.

The asset attributes function to define persistent information about the asset. Examples of asset attributes can include asset geometry, asset shape, asset physics (e.g., mechanics, such as kinematics or material responses; electromagnetism; thermodynamics; acoustics; etc.), and asset components, connections, and constraints. However, the asset can be associated with any other suitable set of asset attributes. The asset attributes are preferably persistent across all versions of the asset, but can alternatively be different (e.g., a lower-fidelity version can lack some degrees of freedom or components). The asset attributes can be represented using different data fidelity (e.g., compression, resolution, framerate, bitrate, degrees of freedom, etc.), data types, data objects, or otherwise represented for different versions; alternatively, different versions of the asset can be stored using the same data object.

The asset parameters function to define the transformations available to the asset (e.g., options that a user can select for the asset). Examples of asset parameters can include rotation (e.g., relative to the scene), position in scene (e.g., relative to anchor point, relative to global reference point), scale, visual parameters or optical characteristics, and/or other parameters that can be adjusted. Visual parameters or optical characteristics can include shading (e.g., color, brightness, etc.), texture, reflectivity (e.g., specularity, etc.), opacity (e.g., transparency, transparency, translucency, etc.), refraction, diffraction, and/or any other suitable parameters that are needed to render content. In examples, the visual parameters can be used to determine which piece of HDR data (e.g., which pre-convolved HDR environment map, which prefilter, etc.) and/or which shader to use to render the asset and/or component thereof.

In examples, asset parameters can also include one or more pieces of audio and/or visual media (AV media) (e.g., asset animations, sound tracks, etc.). The AV media can be static or dynamic. The AV media can be predetermined or dynamically determined. The AV media can be prerendered or dynamically rendered. In a first variant, the AV media is predetermined (e.g., pre-rendered) and played back. In a second variant, the asset is associated with a predetermined model (e.g., behavior model, physics model, etc.), wherein AV media can be generated based on the scene state (e.g., scene geometries, other objects, other objects' attributes, such as the other object's predicted behavior or trajectory, etc.), the asset state (e.g., pose, current action, etc.), and/or other information. In this variant, the AV media can be generated and rendered in real- or near-real time. The behavior model can run locally or remotely (e.g., wherein the information is sent to the remote computing system). In a third variant, a machine learning model (e.g., generative model, diffusion model, transformer, LLM, set thereof, etc.) can be used to generate the AV media for the asset (e.g., predict asset frames or appearance; predict prompts for asset frame generation; etc.). The ML model can generate the AV media based on the scene state, asset state, and/or other information. The ML model can generate the AV media in real- or near-real time. However, the AV media can be otherwise determined.

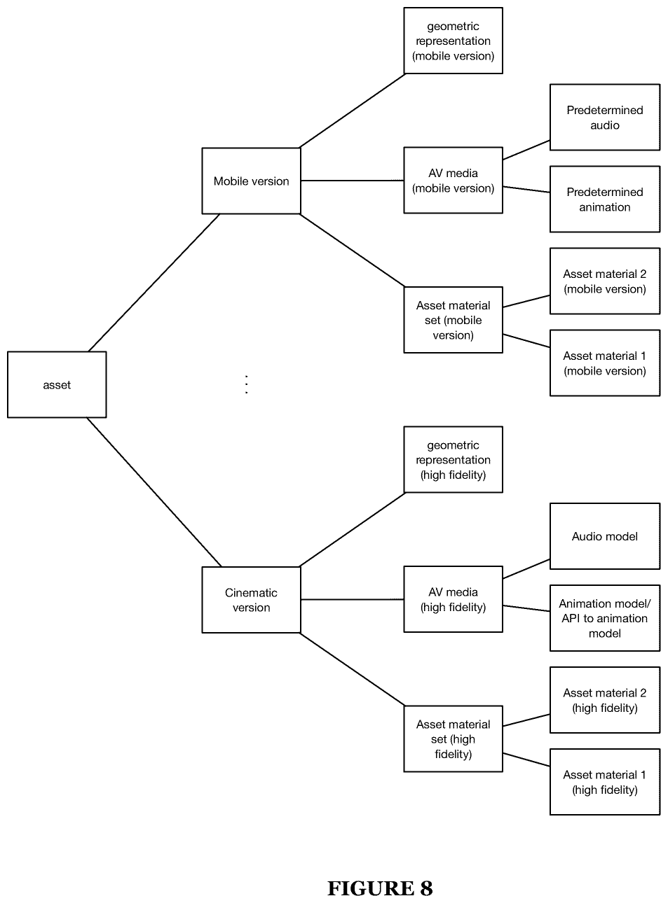

Each asset can be associated with multiple asset versions (e.g., example shown in FIG. 8); alternatively, each asset can be associated with a single version. Different asset versions can have different: fidelity, resolution, compressions, bitrates, polygon count, polygon density, mesh size or mesh density, degrees of freedom, subcomponents, and/or other fidelity metrics. Different asset versions are preferably associated with the same asset identifier, asset attributes, available asset parameters (e.g., wherein the AV media associated with different asset versions can have different fidelities), and/or other asset information. Different asset versions can be: optimized for a given type of device, a given use case, a given amount of available computing power, a given bandwidth, different formats (e.g., .gltf, .blend, etc.), and/or otherwise optimized (e.g., for display, for real-time manipulation and/or rendering, etc.). Different asset versions can be automatically generated from a source asset (e.g., using a set of rules, using a set of target metrics, etc.), or otherwise generated. In operation, the asset version of the asset that is best for (e.g., optimized for) the requesting user interface can be selected and used for extended reality authoring (e.g., used to render the asset over the scene); alternatively, other asset versions can be used.

In variants, different asset versions can be associated with different versions of the same asset parameter, wherein low fidelity asset versions can be associated with low fidelity versions of the parameter. For example, low fidelity asset versions can be associated with low fidelity versions of the AV media (e.g., low pixel density, low resolution, low framerate, stereo or mono-channel audio, deterministic animations, model-based animations, etc.), while high fidelity asset versions can be associated with high fidelity versions of the same AV media (e.g., high pixel density, high resolution, high framerate, multichannel audio, model-based animations, real-time generated animations, etc.). In another example, low fidelity asset versions can be associated with a first rendering method (e.g., displaying a predetermined image segment, using a first shader, etc.) to render a material or visual characteristic of the asset (e.g., specular surface, subscattering, etc.), while high fidelity asset versions can be associated with and/or use a second rendering method (e.g., ray tracing, using a second shader, etc.) to render the same asset material.

Examples of asset versions include a low-quality version, high-quality version, mobile-optimized version, desktop-optimized version (e.g., for native desktop application interaction), streaming-optimized version (e.g., for browser application interaction), high-fidelity version (e.g., high quality, high resolution, high framerate, etc.), and/or other asset versions.

The assets can be stored in standard formats (e.g., glTF, USD, FBX, Blender), custom formats, and/or other formats. The assets can be obtained from (e.g., retrieved from) a digital asset database (e.g., centralized database, distributed database, blockchain, etc.), a marketplace, and/or any other suitable storage.

However, the asset may be otherwise configured.

In variants, the method can also be used with a content object (e.g., Composable) that functions to store data associated with a piece of content. The content object can be a hierarchical data object, a flat data object, or be otherwise configured. The content object is preferably specific to a scene (e.g., physical scene), but can additionally or alternatively be associated with (e.g., represent information for) multiple scenes. The content object can be generated through one or more recording sessions, editing sessions, and/or other authoring sessions. In operation, a device can extract values from all or a subset of the content object (e.g., from all or a subset of modality timeseries, etc.) and generate content using the values. The content can be generated by: rendering frames based on the values (e.g., using a rendering engine); predicting or inferring the frames based on the values (e.g., using a trained machine learning model); and/or otherwise generated.

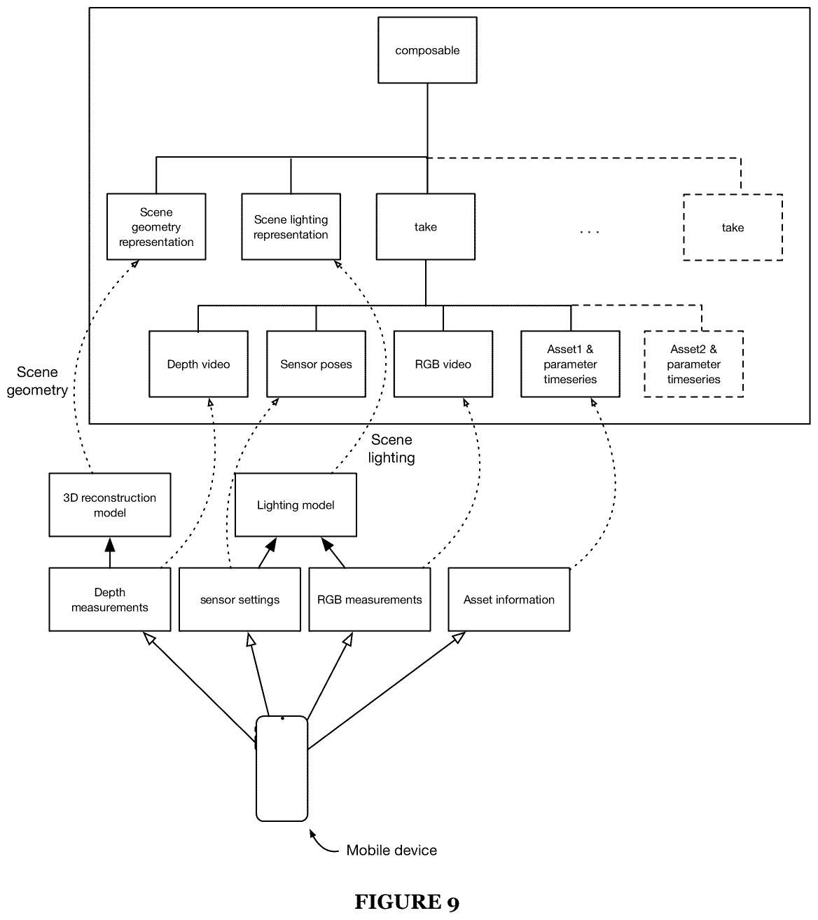

In variants, the content object (e.g., scene representation object, composable, etc.) can store: a set of scene geometric representations, a set of scene lighting representations, a set of takes, and/or other information. An example is shown in FIG. 9.

The scene geometric representation is preferably a 3D representation, but can additionally or alternatively be a 4D representation (e.g., geometry over time), or have any other dimensionality. Examples of scene representations that can be used include: a mesh, surface normal maps, voxel grids, point clouds, signed distance fields, implicit surfaces, NURBS, height maps, scene graphs, octrees, texture maps, UV maps, skeletons, rigging, parametric models, neural scene representations, layered depth images, anchor points, and/or other scene representations. The scene representation can be measured (e.g., by a mobile device located within the physical scene), be generated from measurements (e.g., by extracting or fitting a mesh to measurements; using numerical methods, etc.), be generated using a generative model, and/or otherwise determined.

The scene lighting representation preferably represents HDR information, but can alternatively represent LDR information, light source information, and/or any other information. Examples of scene lighting representations that can be used include: images, environment maps (e.g., spherical maps or cubemaps), skybox lighting, light probes, reflection maps, refraction maps, light fields, volumetric HDR, shadow maps, and/or other representations. The scene lighting representation can be generated using S140 and S150, be virtually generated (e.g., by rendering the lighting using a rendering engine, by generating the lighting using a generative model, etc.), and/or otherwise determined.

Each take can include a set of spatiotemporally aligned timeseries (e.g., videos), wherein different timeseries in the set have different modalities (e.g., represent different types of data). All modality timeseries within a take are preferably spatially registered relative to each other (e.g., relative to a world coordinate system, shared scene coordinate system, etc.), temporally registered or aligned with each other, and/or otherwise aligned; however, different modality timeseries in a take can be misaligned. Different takes can encompass different timeframes (e.g., separate and distinct global times, overlapping timeframes, etc.), different scenes, and/or otherwise differ. Different takes in the same or different composable preferably include timeseries for the same set of modality types (e.g., all takes include RGB, audio, object parameters, etc.), but can alternatively include timeseries for different modality sets (e.g., a first take includes RGB and object identifiers, while a second take includes audio and object skeletons).

The modality information (e.g., values) can be: measured by a sensor (e.g., mobile device camera, etc.), extracted from the scene measurements (e.g., using an object detector, segmentation model, skeleton inference model, etc.), generated by a machine learning model (e.g., generative model, DNN, transformer, etc.), manually specified, and/or otherwise determined. The modality information can be concurrently captured (e.g., by the same device, by synchronized devices, etc.), generated from the same measurements, and/or otherwise generated.

Examples of modalities represented by the timeseries can include: visual data (e.g., RGB), audio, depth, asset information (e.g., asset ID, asset pose, asset material, asset AV media, other asset parameters, etc. for each of a set of assets virtually included within the scene), object information (e.g., object identifiers, object skeletons, object segments, etc.), sensor parameters (e.g., optical sensor parameters), auxiliary sensor measurements (e.g., IMU measurements, gyroscope measurements, temperature measurements, etc.), and/or other data modalities. The sensor parameters can include: sensor pose within the scene (e.g., camera pose in world coordinates, scene geometry coordinates, etc.); ISO, white balance, aperture, color space, focus mode, and/or other camera settings; sensor type; and/or other sensor parameters. Each modality timeseries can include a frame for each of a set of timesteps, wherein each frame includes a set of values for the data mode. A take and/or the asset timeseries preferably does not store the asset variant (e.g., wherein the asset variant is retrieved based on the asset identifier by the rendering device), but can alternatively store the asset variant and/or variant identifier.

All or portions of the content object can be used to: overlay the assets over a view of a real-world scene (e.g., in an XR experience); generate high-fidelity content; train machine learning models; and/or otherwise used. For example, a subset of the content object data can be used to train a model to predict a training target, generated based on all or a subset of the content object values, based on the values of all or a different subset of the information in the content object as a model input. In an illustrative example, a model can be trained to predict a set of 3D frames (e.g., 3D video), rendered based on the content object values (e.g., all values for all pieces of information), when given the scene geometry, lighting representation, a frame from the RGB timeseries, and the asset or object parameter timeseries (e.g., timeseries of skeleton poses). In another illustrative example, a model can be trained to predict the lighting representation from the RGB timeseries. However, the content object can be otherwise used.

However, the content object can be otherwise configured.

However, the system can include any other suitable information.

### 5. Method

As shown in FIG. 1, in variants, the method can include: sampling measurements of the real-world scene S100; rendering extended reality assets relative to the scene S200; determining asset parameters for the asset S300; generating content based on the asset parameters S400; and displaying the content over a view of the physical scene S500. The method can function to generate high-fidelity extended-reality (XR) content using low-quality data authored on a mobile device.

The method can be performed: iteratively (e.g., to iteratively improve the content), once, any number of times for each piece of content, and/or any other number of times. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

In a first example, the high-fidelity content can be generated from single mobile authoring session. In a second example, the high-fidelity content can be iteratively generated from multiple mobile authoring sessions, wherein each authoring session can re-load and adjust the previously authored content (e.g., add or remove assets or content recording, change asset parameters, etc.) (e.g., example shown in FIGS. 6A-6Q). In a third example, scene information can be recorded on-site (e.g., using a mobile device), wherein assets and asset parameters can be added to the scene information asynchronously (e.g., using a desktop device). In a fourth example, the high-fidelity content can collaboratively authored by multiple users (e.g., in a manner similar to the second example). However, the high-fidelity content can be otherwise authored.

The method can be performed by one or more authors (e.g., individually, in collaboration, etc.). The method can be performed using one or more of the system components discussed above, and/or using other components.

Sampling measurements of the real-world scene S100 functions to determine scene data for digital asset positioning and realistic rendering. Sampling measurements of the real-world scene S100 can be performed using a mobile device, more preferably mobile device sensors, but can alternatively be generated by a generative AI model (e.g., from a description, etc.), manually generated, and/or otherwise determined. S100 can be performed once (e.g., during initial scene setup), continuously during content authoring, periodically during content authoring, and/or at any other time. The scene measurements can include: visual measurements (e.g., RGB images, panoramas, and/or any suitable visual measurements), geometric measurements (e.g., LIDAR measurements, point clouds, and/or any suitable geometric measurements), inertial measurements (e.g., accelerometer measurements, gyroscope measurements, and/or any suitable inertial measurements), and other measurements.

In variants, S100 can include capturing scene data S120, capturing light data S140, and/or generating HDR data from the light data S150. However, S100 can be otherwise performed.

Capturing scene data S120 functions to capture spatial, visual, and/or temporal information about the scene. S120 is preferably performed using the mobile device, more preferably the mobile device sensors, but can be generated or otherwise determined. The scene data can be 3D, 2D, 4D (e.g., a video), and/or have any other suitable set of dimensionality.

Scene data can include: visual data (e.g., color images, panoramas, visual features, visual embeddings, visual anchor points, etc.), geometric data (e.g., mesh of the scene, scene planes, point clouds, scene measurements, scene scale, geometric features, geometric embeddings, geometric anchor points, etc.), lighting data (e.g., HDR data, light maps, etc.), object data (e.g., from scene segmentation), and/or other scene data that can be determined from the scene measurements. The features are preferably regions of the scene (e.g., keypoints, planes, pixel blobs, etc.), but can additionally or alternatively include embeddings, encodings, and/or other features.

The geometric data can include planes (e.g., determined using planefinding techniques), mesh representation of the scene (e.g., determined using depth techniques, mesh generation techniques, and/or any suitable techniques), point clouds, model, neural radiance field, gaussian splatting, and/or other representations. The geometric data can also include anchor features (e.g., unique geometric features of the scene). The anchor features are preferably associated with a nonmobile object, but can alternatively be associated with a mobile object.

The object data can include object identifiers (e.g., determined using an object detector), object segments (e.g., segmented based on visual features, geometric features, and/or any suitable features), object classifications (e.g., whether the object is stationary or will move; can be determined based on known motion characteristics associated with the object identifier or be independently classified), and/or tother object data.

Scene data can be generated by the mobile device, by the remote computing system (e.g., wherein the measurements are sent to the cloud for processing), by a user, and/or otherwise generated. Scene data can be generated in real-or near-real time, asynchronously, and/or at any other time. Scene data can be generated once (e.g., when the session is being initialized), iteratively (e.g., during content authoring, during an authoring session), and/or at any other time. Scene data is preferably generated from the sampled measurements (e.g., sampled during the session), but can additionally or alternatively be generated from simulations, digital models of the scene, user descriptions, and/or from any other information.

Capturing scene data S120 can include: capturing visual data, capturing geometric data, capturing audio data, and/or capturing other data.

Capturing visual data can include sampling images using the camera (e.g., example shown in FIG. 41). Images can be single frame, multi-frame, panoramas, videos, and/or other images.

Capturing geometric data can include sampling geometric measurements of the physical scene (e.g., example shown in FIG. 4J). In a first variant, the geometric data is determined from depth measurements and camera pose during measurement. Depth measurements that can be used can include LIDAR measurements, projected light, and/or other depth measurements. In a specific example, geometric data can be captured using AR kit LIDAR meshing features to create a mesh in real-time on the device. In a second variant, the geometric data is determined from stereopairs or visual odometry. In a third variant, the geometric data is determined from a monocular image (e.g., depth and geometries estimated by a trained ML model). In a specific example, capturing scene data S120 can include sampling scene using AR kit.

All modalities of scene data are preferably captured at the same time (e.g., to maintain inter-modality registration), but can alternatively be captured at different times.

In variants, capturing scene data S120 can include instructing user to sample an image, a panorama, or a 360 degree capture of the scene.

In variants, S120 can also create a digital representation of the physical environment from the scene measurements (e.g., using a trained model, using reconstruction techniques, etc.). This digital representation can serve as a backdrop or reference for placing and orienting the extended reality assets.

In an example, capturing scene data S120 can include: determining the scene depth (e.g., for each pixel) for each frame, determining the camera pose relative to the frame, and performing an SDF (signed distance function) reconstruction of the scene from the scene depth, the frames, and the camera pose to generate a scene representation (e.g., a high quality mesh). In variants, the scene depth can be generated from multiple depth estimation modalities (e.g., monocular depth estimation, stereo depth estimation, visual-inertial odometry, etc.). In an example, monocular depth estimation can be combined with LIDAR depth measurements to generate a scene representation with accurate metric scale. In another example, depth estimations from different modalities can be fused reconstruct a higher fidelity depth map.

However, the scene representation can be otherwise determined.

The captured scene data can optionally be refined or augmented by the remote computing system. Modified scene data can be used for cloud rendering or high-fidelity content rendering, be sent back to the mobile device for real-time rendering, and/or otherwise used.

However, capturing scene data S120 may be otherwise performed.

Capturing light data S140 functions to accurately represent lighting conditions for realistic rendering. capturing light data S140 can be generated by the mobile device, by the remote computing system (e.g., wherein the measurements are sent to the cloud for processing), and/or by any other system. S140 can be performed in real-or near-real time; before and/or after the authoring session, S200, S300, and/or S400; and/or at any other time. capturing light data S140 can be generated while in AR experience (e.g., to ensure correct directionality), concurrently with S120, after S120, and/or at any other suitable time.

Light data is preferably generated from the sampled measurements (e.g., sampled during the session), but can additionally or alternatively be generated from simulations, digital models of the scene, user descriptions, and/or from any other information. Light data can be generated from the same measurements used to determine the scene data, generated from light measurements sampled concurrently with the scene measurements (e.g., such that the light measurements are spatially and/or temporally registered to the scene measurements), generated from light measurements sampled separately from the scene measurements, and/or from any suitable set of measurements.

Light data for the scene can be generated once (e.g., when the session is being initialized), iteratively (e.g., during content authoring), for each authoring session, for each physical scene reentry, when substantial lighting conditions changes are detected, and/or at any other time.

Capturing light data S140 can include sampling a reference image of a reference region in the scene, determining sensor settings (e.g., camera settings) based on the image of the reference region, locking the sensor settings (e.g., camera settings) to maintain consistent exposure for remainder of the LDR capture session, capturing LDR data of the scene (e.g., LDR images, LDR environment maps, etc.) while sensor settings are locked, optionally specifying the light capture context, and/or any other suitable processes.

Sampling a reference image of a reference region in the scene functions to determine scene information for the camera settings determination (e.g., for subsequent LDR capture). The reference region is preferably illuminated by all or a majority of the light sources in the scene, but can alternatively be illuminated by a minority of the light sources in the scene. The reference region is preferably the ground (e.g., floor), but can additionally or alternatively be a ceiling, a surface near the volumetric center of the room (e.g., a table top), a wall, and/or any other suitable region. Alternatively, the reference region in the scene can be a panorama, a 360 degree image of the scene, and/or any other image of the scene.

Sampling the reference image of the reference region in the scene can optionally include referencing the image of the reference region to world coordinates. Referencing the image of the reference region to world coordinates can be based on auxiliary sensor data sampled during reference region image sampling, such as GPS, heading, relative pose after identifying a scene spatial anchor (e.g., while in AR experience), and/or other auxiliary sensor data.

However, sampling the reference image of the reference region in the scene may be otherwise performed.

Determining sensor settings (e.g., camera settings) based on the image of the reference region functions to determine the camera settings that will enable the LDR data to represent as much of the lighting information with as much accuracy as possible. The sensor settings that are determined can include the shutter speed, ISO, white balance gains, exposure, and/or any suitable sensor settings.

The sensor settings are preferably determined based on the image of the reference region, but can alternatively be manually determined or otherwise determined.

In a first variant, the sensor settings are determined by determining the camera settings used to sample the image of the reference region (e.g., example shown in FIG. 4E). Since the reference region is illuminated by all or majority of the light sources in the scene, these camera settings already account for the lighting variance across the scene.

In a second variant, the sensor settings are determined by inferring camera settings based on ambient intensity.

However, determining sensor settings (camera settings) based on the image of the reference region may be otherwise performed.

Locking the sensor settings (e.g., camera settings) can maintain consistent exposure for remainder of the LDR capture session and set the 0-1 LDR value range for the LDR data capture. Locking the sensor settings can aim to avoid clipping beyond 1 to preserve recoverable data. Locking the sensor settings provides a ground truth baseline for sensor settings at capture time. For example, locking the sensor settings can provide consistent exposure. Locking the sensor settings prevents the sensor settings from automatically varying while the remainder of the scene LDR data (e.g., image, environment map, etc.) is sampled. For example, locking the sensor settings can prevent auto-exposure changes that would cause inconsistencies. The sensor settings are preferably locked to the settings used to determine the reference image, but can alternatively be locked to a predetermined set of values or otherwise fixed.

However, locking the sensor settings (e.g., camera settings) may be otherwise performed.

Capturing LDR data of the scene (e.g., LDR images, LDR environment map, etc.) while sensor settings are locked functions to obtain information about the real-world scene within a specific dynamic range. This step can ensure that the LDR values are between 0-1 range, and/or ensure that the 0-1 LDR range encompasses a majority of the lighting parameters within the scene. The LDR capture session can be the same as the scene data capture session, or be a different session (e.g., before, after, or concurrent with scene data capture).

In a first variant, capturing LDR data can include capturing the measurements (e.g., the scene data, a panorama, etc.) using the locked sensor settings (e.g., example shown in FIGS. 4F-4H).

In a second variant, capturing LDR data can include capturing a low dynamic range (LDR) image or LDR environment map.

In a third variant, capturing LDR data can include capturing multiple LDR images (for exposure stacking). For example, multiple images of the same scene at different exposure levels (underexposed, correctly exposed, overexposed) can be captured.

In variants, the sensor settings can be unlocked for the remainder of the authoring session (e.g., during asset addition, while recording, and/or at any other time).

However, LDR data may be otherwise captured.

Capturing the light data S140 can optionally include determining the light capture context, which functions to guide subsequent HDR data generation from the LDR data (e.g., example shown in FIGS. 4C-4D). For example, different light capture contexts can be associated with different filters, HDR generation modules, and/or other downstream processes. The light capture context can be manually determined (e.g., received from a user), automatically determined (e.g., based on light intensity analysis, geolocation analysis, etc.), and/or otherwise determined. The light capture context can include spatial classification (e.g., indoor/outdoor), light source classification (e.g., natural/artificial), and/or any suitable other contextual parameters.

However, the light capture context may be otherwise determined.

However, light data may be otherwise captured.

In variants, the method can also include generating HDR data from the light data S150, which functions to recover or generate high dynamic range lighting information from LDR input, to recover highlight and shadow detail, to enable accurate representation of bright light sources and shadows, to allow for realistic lighting of virtual objects in AR scenes, and to provide data needed for physically-based rendering techniques.

S150 can be performed at a remote computing system, wherein the LDR data is received from the mobile device. S150 can be performed using the HDR data generation module and/or by any other suitable module. Alternatively, S150 can be performed at the mobile device.

S150 is preferably performed in real- or near-real time (e.g., immediately after LDR data capture, during the authoring session, immediately after scene initialization, while the user is selecting or manipulating the asset, and/or at any other suitable time), but can additionally or alternatively be performed asynchronously (e.g., after the authoring session), and/or performed at any other suitable time.

The HDR data is preferably generated based on LDR data captured by the mobile device and camera settings associated with the LDR data capture, but can additionally or alternatively be generated from other data. For example, the LDR environment map is captured and sent to the cloud during the authoring session, wherein modules in the cloud generate one or more HDR environment maps.

The HDR data preferably encompasses (e.g., depicts, represents light information for) the same scene region as the LDR data, but can additionally or alternatively encompass more or less of the scene. For example, the HDR data can be for a segment of the scene, a panorama of the scene, a 360 sphere of the scene, and/or any other suitable segment of the scene. The HDR data can be registered to the LDR data (e.g., share the same reference frame), registered to the scene (e.g., to an anchor point), or be unregistered. The HDR data is preferably specific to the scene and not specific to an asset, but can alternatively or additionally be specific to an asset.

In a first variant, the HDR data can include (or be) an HDR environment map. The HDR environment map can be a panorama, image of the asset from a viewing angle, image of a component of the asset, image of the scene, image of a part of the scene, and/or any other suitable environment map or scene representation. In a first example, the HDR environment map only depicts the asset. In a second example, the HDR environment map only depicts a component of the asset. In a third example, the HDR environment map depicts the scene. The HDR environment map can be 2D, 3D, or 4D (e.g., video). The HDR environment map can be generated directly from LDR data, or be generated indirectly, by identifying lighting parameters from the LDR (e.g., light source type, pose, color, temperature, hue, intensity, and/or any other suitable parameters), determining the physical properties of the scene (e.g., geometries, textures, relative poses, and/or any other suitable properties), and using ray tracing or other methods to render the HDR environment map.

In a second variant, the HDR data can be a lightmap (precomputed lighting information in textures), environment map, or cube map.

In a third variant, the HDR data can be a light probe.

In a fourth variant, the HDR data can be a volumetric light map (e.g., include lighting information in 3D grids). The grid information can update over time to capture spatiotemporal effects, remain static, or be otherwise updated.

In a fifth variant, the HDR data can be an image.

The HDR data can include only lighting information (e.g., consist essentially of lighting data), only include RGB data, include lighting information and RGB data, and/or any other information.

One or more pieces of HDR data (e.g., multiple HDR images) can be generated from the LDR data. When multiple pieces of HDR data are generated, different HDR data can have the same or different: resolution (e.g., high resolution, low resolution, etc.), lighting parameters (e.g., different color, tone, hue, saturation, light source pose, etc.), levels of light diffusion/blurriness, texture or material properties (e.g., metallic surfaces, reflective surfaces, diffuse surfaces, etc.), scale, depicted scene segment, and/or otherwise differ. Different HDR datum can be for the same or different perspectives of the digital asset, components of the digital asset, regions of the scene, perspectives of the scene, scene arrangements (e.g., lighting arrangements, object arrangements, etc.), and/or otherwise be the same or differ. Different HDR datum can be used under different rendering conditions or otherwise used. For example, high-resolution versions can be used to render shiny, metallic surfaces. Low-resolution versions can be used to render diffuse, matte surfaces. This can enable more accurate real-time lighting loading, instantiation, and simulation on mobile devices. In a first variant, different pieces of HDR data are directly generated from the LDR data (e.g., using an ML pipeline, etc.). In a second variant, a single HDR datum is generated from the LDR data, wherein the HDR datum is postprocessed (e.g., convoluted, filtered, etc.) to generate multiple pieces of HDR data (e.g., HDR prefilters, pre-convolved HDR environment maps, etc.). However, the multiple pieces of HDR data can be otherwise generated.

The HDR data can be associated with: a set of camera settings (e.g., exposure, and/or any other suitable settings), HDR generation parameters (e.g., resolution, blur, lighting, texture, and/or any other suitable parameters), and/or other HDR parameters. This auxiliary HDR information can be used to select which piece of HDR data to use when rendering the asset (or components thereof), or otherwise used.

All or a portion of the HDR data can be sent back to the mobile device for real-time asset rendering, used by the remote computing system to render high-fidelity content, or otherwise used.

In a first variant, when the HDR data is sent back to the mobile device, the HDR data can be sent back piece by piece (e.g., streamed datum by datum, image by image, environment map by environment map, prefilter by prefilter, etc.).

In a second variant, when the HDR data is sent back to the mobile device, the HDR data can be sent as a compressed bundle, wherein the mobile device decompresses the bundle.

In a third variant, when the HDR data is sent back to the mobile device, a numeric representation of the HDR data can be sent to the mobile device, wherein the mobile device creates the HDR data using the numeric representation. The numeric representation can include a sign, an exponent (e.g., that represent the scale of brightness for HDR pixels), a mantissa, and/or other information. All or a portion of the numeric representation can be sent to the mobile device. In a first example, only the exponent is sent to the mobile device. In a second example, HDR information can be stored by decomposing the HDR values into RGB color and an exponent, then packing the exponent value into the alpha channel while storing RGB data in the standard channels using a RGBD encoding process. This can enable real-time decoding on mobile GPUs and can preserve a wide dynamic range in limited texture format. However, the numeric representation can be otherwise stored. The numeric representation can be stored in RGBE format (Radiance HDR format), custom format (e.g., by storing the exponent in an existing channel), textures (e.g., KTX GPU textures), and/or other format.

Generating HDR data from the light data S150 can be performed by one or more modules. The modules can include algorithmic techniques, machine learning models, and/or other modules.

In a first variant, HDR data can be generated using algorithmic techniques. Examples of algorithmic techniques that can be used can include inverse tone mapping, local contrast enhancement, exposure stacking, inpainting and extrapolation, histogram expansion, gaussian pyramids, simulated exposure fusion, multi-exposure bracketing (capturing multiple exposures and merging), deep learning-based HDR reconstruction, physical-based light modeling and estimation, hybrid approaches combining multiple techniques, and/or any other suitable techniques.

In a second variant, HDR data can be generated using machine learning models. The ML models can learn complex, non-linear relationships between LDR and HDR data, handle a wide variety of lighting conditions and scenes, recover more detail in highlights and shadows, adapt to different camera sensors and response curves; and/or perform other functionalities. The ML models can be: CNN, DNN, RNN, generative models, and/or any other suitable model type. The inputs to the models can be LDR data, camera settings, HDR data generated using another technique (e.g., algorithmic technique), and/or other inputs. The outputs from the models can be one HDR datum (e.g., image, environment map, etc.) or multiple HDR data (e.g., images, environment maps, etc.). The LDR input modality can be the same or different from the HDR output modality (e.g., LDR images in, HDR environment maps out; LDR environment maps in, HDR images out, etc.). The models can be trained using LDR data paired with HDR data. The model can be trained to predict HDR data given input LDR data. The model can be trained to predict the missing HDR data from LDR inputs. The model can be trained to predict HDR datum (e.g., prefilters, etc.) with different parameters given a seed HDR datum. The parameters can include different exposure, different lighting conditions, different resolution, different scale, and/or any other suitable parameters. However, the model can be otherwise trained.

In a specific example, S150 can include generating an HDR panorama from LDR data (e.g., using inverse tone mapping, etc.), optionally generating secondary HDR panoramas using a machine learning model (e.g., using the HDR panorama), and generating a cube map with multi-resolution level of detail (MIP) levels.

In another specific example, S150 can create diffuse and specular convolution maps.

In variants, the HDR data can be post-processed after generation (e.g., to generate additional HDR data).

In a first variant, post-processing the HDR data can include subsampling the HDR data to generate lower resolution HDR data. In a specific example, S150 can generate different HDR environment maps representing light maps at different resolutions, representing various levels of convolution, and/or representing other information, wherein the different HDR environment maps can be dynamically selected for real-time use (e.g., to quickly simulate realistic lighting on mobile in real- or near-real time).

In a second variant, the HDR data can be adjusted based on the capture context. Each capture context can be associated with a predetermined set of filters, weights, thresholds, shaders, and/or other adjustments. Adjusting the HDR data can include: dynamically scaling HDR range based on lighting conditions (e.g., using a wider range for outdoor scenes with bright sunlight and using a narrower range for indoor scenes with artificial lighting), correcting color contamination issues (e.g., desaturating blue sky values in indoor scenes), adjusting highlight clipping to better represent sky brightness (e.g., in outdoor scenes with natural lighting), compensating for exposure and white balance, and/or adjusting light intensity multipliers for different environment types.

In an example, generating HDR data S150 can include: receiving LDR data (e.g., an LDR environment map capture); converting the LDR data to HDR data (e.g., using machine learning); and using HDR convolution to generate different pieces of HDR data (e.g., at the remote computing system) that can be dynamically selected based on an asset's appearance parameters to present (e.g., render) the asset within the scene (e.g., on the mobile device). HDR convolution can include: prefiltering an HDR environment map (e.g, generated from the LDR environment map) to produce multiple levels of blur, each corresponding to a different roughness level of a material. When rendering an asset, the renderer (e.g., on the mobile device, on the remote computing system, etc.) samples the associated pre-convolved map based on the surface roughness. This makes reflections, ambient lighting, and materials appear more physically accurate in real time, without the need for the intensive path tracing calculations at the edge. This can also enable the user to preview and control dynamic camera settings like exposure and white balance with real-time feedback.

However, generating HDR data from the light data S150 may be otherwise performed.

Rendering extended reality assets relative to the scene S200 functions to visualize digital assets in the real-world context. For example, S200 can include generating visual representations of virtual objects, characters, or effects that are integrated with the captured scene data.

S200 is preferably performed by the mobile application executing on the mobile device, but can additionally or alternatively be performed by a desktop application, browser based application, and/or any other suitable application or interface executing on a computing device, the remote computing service, and/or any other suitable computing system. S200 can be performed: after scene sampling, during user interaction, during the authoring session, after the authoring session, and/or at any other suitable time. S200 is preferably iteratively performed (e.g., in real- or near-real time, as the asset parameters are adjusted and/or as the mobile device and/or user moves within the scene), but can alternatively be performed once for each piece of content, once for an authoring session, and/or any other number of times. S200 can render the XR assets in real-time, during the authoring session (e.g., to enable dynamic updates of the extended reality assets as the user moves or interacts with the environment); employ pre-rendered assets that are composited with the real-world scene in real-time (e.g., for complex assets or scenes that require extensive computational resources); and/or render the assets at any other time. When the assets are associated with AV media, the AV media can be generated and/or rendered frame-by-frame using these methods discussed herein, or be otherwise generated.

S200 can include receiving an extended reality asset (XR asset); positioning the asset relative to the scene; and displaying the asset relative to the scene.

Receiving the XR asset functions to obtain the version of the asset to be displayed. The XR asset can be a digital asset, a physical asset that is digitized (e.g., object in the scene that is digitized and subsequently manipulated), and/or any other asset. The XR asset can be an AR asset, VR asset, or any other digital asset. The XR asset can be 2D, 3D, and/or have any other suitable set of dimensionality. The XR asset can be associated with: an asset identifier, asset appearance (e.g., color, texture, etc.), asset geometry (e.g., scaled or unscaled), shaders (e.g., to render asset appearance based on lighting data), and/or other information. The XR asset can be static or be associated with one or more pieces of AV media (e.g., animations, soundtracks, AI-generated animations, etc.). The XR asset can be selected (e.g., by a user), received (e.g., retrieved) from an asset storage (e.g., library or database), marketplace, or alternatively obtained from another data source.

The asset information can be retrieved from storage. In a first example, the information needed to render the asset is retrieved. In a second example, the render of the asset is retrieved. The asset storage can be: local (e.g., on the mobile device), remote (e.g., in the remote computing system), distributed (e.g., on a cryptographic system, such as a blockchain), and/or otherwise structured. The XR asset can be retrieved based on an asset identifier (e.g., unique asset identifier), a semantic name, or alternatively otherwise retrieved. Examples of XR asset formats that can be used to store the asset include USDZ, GLTF, Blender, custom formats (e.g., composables), and/or other formats.

The retrieved XR asset is preferably an asset version of a digital asset, but can additionally or alternatively be a standardized version of the digital asset. Each asset can be associated with one or more versions of the asset (asset versions). The asset version can be a version optimized for the rendering device (e.g., device rendering the asset), a version optimized for the interface rendering the asset (e.g., whether a mobile application, desktop application, or rendering engine is being used to render the asset), and/or otherwise selected. Asset versions can include: mobile version, per-SKU version (e.g., version for a given devices' make, model, operating system, etc.), per-application version (e.g., version for each displaying application, such as an authoring version, Youtube version, TikTok version, etc.), desktop version, cinematic version, and/or other versions.

Different asset versions can have different asset attributes. Asset attributes, which specify the fidelity of the displayed asset, are preferably different from asset parameters, which specify how the asset display should be adjusted. However, the asset attributes can additionally or alternatively include or be the same as asset parameters. For example, a mobile version of the digital asset has lower fidelity (e.g., lower resolution, higher compression, lower framerate, etc.) and different shaders (e.g., configured to shade at the lower fidelity) than a desktop version or cinematic version of the digital asset.

In an example, a user selects an asset identifier (e.g., example shown in FIG. 5B), the interface retrieves the asset version of the asset to use, and the interface displays or renders the asset version of the asset relative to the scene (e.g., example shown in FIG. 5D). The displayed asset version can be rendered by the display device, rendered by a remote rendering service (e.g., executing on the remote computing system) and sent to the display device for display, and/or otherwise rendered.

S200 can include positioning the asset relative to the scene (e.g., example shown in FIG. 5C). The asset can be virtually positioned based on the geometric features of a scene, such as based on planes detected in the scene or based on scene depth. The asset pose can be stored as an asset parameter (e.g., in S300). The asset can be automatically positioned or manually positioned, wherein the asset is rendered at the virtual pose. The asset pose is preferably tracked relative to an anchor feature in the scene, wherein the anchor feature associated with the asset can be automatically determined or manually specified, but can be otherwise tracked.

In variants, S200 can include automatically scaling the asset based on depth (e.g., based on the depth of the asset's position within the scene), automatically obscuring based on obstructions between the asset and the camera (e.g., wherein obstructing objects are identified in the scene, and segments of the asset behind the obstructing objects are masked out and/or not projected into the virtual camera), and/or otherwise transforming the asset.

S200 can include rendering the asset relative to the scene. Rendering the asset functions to provide a real-time preview of the asset within the scene. The asset is preferably rendered over a view of the real-world scene. The view of the real-world scene can be an image of the scene, a view through a lens, and/or other view of the scene. In variants, S200 can include sampling images of the real-world scene (e.g., in real-time), detecting and tracking features in the scene (e.g., anchor points, geometric features, unique visual features, etc.), and rendering and overlaying the asset version of the asset over the images, wherein the asset is anchored to the detected scene features.

The XR assets can be rendered using the asset attributes, the asset parameters, the scene's HDR data, and/or other information. The XR assets can be rendered using: ray tracing, rasterization, or any other suitable rendering method. These techniques can be applied to create realistic lighting, shadows, and reflections on the extended reality assets based on the captured light data.

Rendering the XR assets can optionally include playing media (e.g., animations, audio, etc.) of the asset (e.g., transformed based on the asset parameters determined in S300), applying visual effects to the scene (e.g., motion blur, depth of field, ambient occlusion, etc.), adjusting the appearance of extended reality assets based on the lighting conditions captured in the light data (e.g., modifying the brightness, color, and shadows of the assets to match the illumination of the real-world scene, using the HDR data, etc.), and/or otherwise rendering the XR assets.

Rendering can be performed using HDR data. In a first variant, this can be done by selecting HDR data (e.g., the prefilter, the preconvolved map, etc.) associated with a visual parameter of the asset or asset component (e.g., surface texture, etc.) and/or the current camera settings (e.g., manually determined settings, automatically determined settings for the current scene, etc.), and rendering the asset using the selected HDR data (e.g., the sampled HDR data). In an example, the asset is rendered by sampling a preconvolved HDR map (e.g., sampling the map from a set of maps, sampling points or regions from the map, etc.) based on the asset's surface parameter (e.g., texture) and the current camera settings (e.g., of the mobile device, such as white balance, exposure, etc.), and rendering the asset or component thereof using the preconvolved HDR map. In a second variant, this can involve dynamically adjusting per-frame exposure based on the real-time sensor recordings of shutter duration and ISO, as compared to the original LDR capture configuration. In an example, the rendered virtual overlay assets are dynamically rerendered given the current device's camera parameters (e.g., shutter duration and ISO), based on the difference between the current device's parameters and the capture device's parameters (e.g., capture shutter duration and ISO). This allows the computer-generated layer to correctly expose up and down to match the real-world exposure, resulting in a seamless visual representation of the lighting that matches that of the recorded footage. In a specific example, the HDR data associated the current camera settings can be retrieved and used to rerender the asset. In variants, lighting source poses relative to the scene can be identified (e.g., from auxiliary data, based on the sampling time of day; from reflections or lighting features within the sampled scene; etc.) and used to render the XR assets.

In a first variant, S200 can include retrieving images of the asset (e.g., based on the asset parameters, the HDR data, etc.), optionally compositing segments from different asset images together, and displaying the retrieved asset image. For example, S200 can include retrieving HDR images of different asset components based on the respective components' asset parameters (e.g., material, texture, etc.), and compositing the HDR images together based on the components' respective positions in the asset.

In a second variant, S200 can include generating and/or rendering the XR assets (e.g., based on the asset parameters, the HDR data, etc.) on the displaying device. For example, S200 can include retrieving the asset attributes (e.g., geometry, visual parameters, etc.), determining which HDR data to use based on the asset parameters (e.g., texture, etc.) and/or camera settings (e.g., automatically adjusted camera settings), retrieving the identified HDR data (e.g., prefilters), and rendering the asset using the HDR data and the asset attributes. The XR assets can be rendered using: ray tracing, rasterization, or any other suitable rendering method. These techniques can be applied to create realistic lighting, shadows, and reflections on the extended reality assets based on the captured light data. In a first example, this can include identifying different HDR prefilters (e.g., pre-convolved HDR environment maps prefiltered at different levels of blur) for different asset components, selected based on the respective asset parameters for the component, and rendering each component using the respective HDR prefilter. In a second example, this can include identifying the light maps for different asset components, selected based on the asset parameters for the respective component (e.g., texture, pose within the scene, etc.), and rendering each component using the light map (e.g., using a shader specific to the component's asset parameter). However, the XR asset can be otherwise rendered.

However, rendering extended reality assets relative to the scene S200 may be otherwise performed.

Determining asset parameters for the asset S300 functions to ensure correct placement and behavior of digital assets. S300 can performed by a user and determined on a user interface (e.g., an authoring application; be automatically determined (e.g., using default asset parameters); and/or otherwise performed.

S300 can be performed on a mobile device, using a mobile application; on a remote computing device or computer (e.g., laptop) using a desktop application, browser-based application, or cloud application; and/or performed on any other suitable device using any other suitable application.

S300 can be performed after S100, during S100, during an authoring session, before recording content, while recording content (e.g., example shown in FIG. 5C), after recording content (e.g., post-processed on another device, using another application, etc.; example shown in FIGS. 6A-6Q), during S200, after S200, or at any other time. S300 can be determined once, iteratively determined (e.g., updated as user modifies asset placement, asset properties, and/or determined any number of times.

Asset parameters can include a single set of parameter values, a timeseries of parameter values, and/or any other set of values.

Asset parameters are preferably manually determined, but can additionally or alternatively be automatically determined (e.g., by a machine learning model, according to a set of rules, and/or otherwise selected. Asset parameters can be manually selected from dropdowns (e.g., with values for parameters associated with the asset), using gestures (e.g., pinching gestures, swiping gestures, dragging and dropping, etc.) and/or otherwise selected.

Asset parameters can be transient (e.g., used to update the rendered asset in the interface in real-time, or recorded (e.g., saved). Asset parameters can be recorded when recording content (e.g., when a record input is received), recorded at all times, and/or otherwise recorded.

Asset parameters can include asset transformations, such as position, rotation, and/or scale relative to a scene anchor point, geometric features, visual features, a global reference frame, a local reference frame, and/or any suitable reference. Asset parameters can include asset appearance, such as color, texture, translucency, material properties, shaders (e.g., for different asset parameters, for different segments of the asset, etc.), which HDR datum should be used to render different components of the asset (e.g., determined based on the asset component's visual parameters), reflectivity, transparency, opacity, specularity, roughness, metallic properties, emissive properties, normal mapping, bump mapping, displacement mapping, ambient occlusion, subsurface scattering, and/or any suitable appearance parameter. Asset parameters can include audio-visual media parameters, for example: which piece of AV media to play, AV media start and/or stop timestamps, AV media playback segments, when during the generated content to play the AV media, and/or any suitable AV media parameter. Asset parameters can include audio parameters, for example: which audio clip to play, audio playback segments, audio start and/or stop timestamps, and/or any suitable audio parameter. Asset parameters can include physics parameters, for example: mass, friction, lighting parameters for virtual light sources, and/or any suitable physics parameter. Asset parameters can include interaction parameters (e.g., for interacting with objects in the scene, etc.), animation parameters, particle system parameters, procedural generation parameters, and/or any suitable asset parameter.

The asset is preferably rendered according to the asset parameters (e.g., updated), in real time on the authoring device, (e.g., in the mobile application), but can additionally or alternatively not be rendered based on the asset parameters. In a first example, the asset can be dynamically enlarged or shrunk when the asset scale is changed. In a second example, S300 can dynamically change the color of different segments of the asset when a new color is selected for the asset segment (e.g., example shown in FIG. 6A-6Q). In a third example, asset position, orientation, and amount of obstruction can be dynamically changed when a new asset pose is selected (e.g., by dragging and dropping the asset. In a fourth example, a different HDR datum (e.g., environment map) is used to render the asset when the visual parameters are changed.

In a first variant, S300 can dynamically change which piece of HDR data is used to render an asset segment based on asset parameter selection. In a first example, S300 can render an asset component using high resolution HDR datum when the asset component is set to reflective; render an asset component using low resolution HDR datum when the asset component is set to diffuse. In a second variant, S300 can dynamically select which piece of HDR data to use for rendering based on the camera settings. For example, S300 can select which HDR datum to use based on the automatically determined camera exposure level.

In an example, S300 can include: while displaying an asset (e.g., identified by an asset identifier) as an extended reality overlay over a view of the scene (e.g., an image of the scene, the scene as viewed through translucent or transparent lenses, etc.), receiving a set of asset parameters for the asset from the user (e.g., position, rotation, scale, shader selections for different segments of the asset, etc.), and displaying (e.g., after transforming or re-rendering) the asset based on the respective set of asset parameters (e.g., based on the selected colors, the HDR data determined based on the selected asset visual parameters and pose relative to the scene, etc.). This can be repeated for other assets in the scene. Upon receipt of a record input, (e.g., record button selection, etc.), the system can record the extended reality scene (e.g., with the updated assets, the asset information, (e.g., asset identifiers, respective asset parameter sets, etc.), the scene information (e.g., scene measurements, scene geometries, sensor settings, sensor pose relative to one or more anchor points, light data, etc.), recording information (e.g., camera pose relative to the scene, camera perspective, camera settings, etc.), and/or other information. The information is preferably concurrently recorded, but can additionally or alternatively be contemporaneously, asynchronously, and/or otherwise recorded. The content information can optionally be sent to the remote computing system for storage and/or high-fidelity rendering (S400). The content information can optionally be sent to a secondary device for further modification (e.g., asset addition, asset parameter selection, etc.) (e.g., examples shown in FIGS. 6A-6Q).

In a specific example, receiving the set of asset parameters can include receiving an audio-visual media selection for the asset (e.g., an animation selection for the asset), playing the asset audio-visual media (e.g., as an extended reality overlay), receiving a recording start input at a first AV timestamp (e.g., a first time within the animation), and receiving a recording stop input at a second AV timestamp (e.g., a second time within the animation). The resultant set of asset parameters associated with the asset can include: the AV identifier, the start AV timestamp, the second AV timestamp, and/or the AV segment between the first and second AV timestamp. This can allow users to identify which segments or loops of the AV media should be used to subsequently generate the content.

In variants, content information, such as asset data (e.g., the asset identifier, asset parameters, etc.) and scene data, can be stored in response to a record input (e.g., selection of a record button, selection of a save icon, etc.), continuously saved, and/or saved at any other time. In a first variant, the content information (e.g., content definition) includes the asset data (e.g., asset identifiers, asset parameters, asset anchor points within the scene, etc.), the lighting information, the scene geometry, and the scene visuals (e.g., images). In a second variant, the content information includes the asset data and the scene measurements. However, the content information can be otherwise defined.

In variants, S300 can optionally include sending the asset parameters to the rendering engine after determination (e.g., example shown in FIG. 2). The asset parameters can be sent after asset parameter selection, after recording completion, (e.g., after a take has been captured), after the user has saved the asset parameters, after the authoring session, and/or at any other suitable time. Asset identifiers, scene measurements, (e.g., sampled during S100, S200, a recording session, etc.), lighting information, and/or other content information can optionally be sent with the asset parameters. In a first variant, all content information is packaged together into a scene representation. In a second variant, asset identifiers and associated asset parameters are packaged independently from scene-specific information (e.g., scene measurements, lighting information, and/or any suitable information. In a third variant, information for each asset (e.g., identifier and associated asset parameters, are individually packaged. However, the content information can be otherwise packaged.

In specific examples, the scene representation and/or asset information can be stored in a Composable format (composables), stored in a standard format (e.g., .gltf, .usd, .fbx, .blend, etc.), or otherwise stored.

Composables can store the asset information (e.g., attributes, parameters, etc.), for a single asset or multiple assets in the same scene.

Composables can be used to create complex 3D scenes by combining multiple assets and other composables, optimize content for different platforms (e.g., mobile, desktop, cloud, using variants, enable easy updates and modifications to scenes without altering original assets, facilitate efficient loading and rendering of 3D content in applications, and support workflows like remote auditing, where scenes can be edited on desktop and synced back to mobile devices.

By using composables, the system can manage complex 3D scenes, optimize performance, and enable flexible workflows for creating and editing extended reality content.

In an example, the composable format can enable representation of 3D asset variants in different formats. For example, a 3D model can be uploaded in a specific file type (e.g., .glb, .usdz, or .blend), and the system will automatically generate appropriate versions for mobile (e.g., high efficiency, low fidelity), and desktop (e.g., high quality, high fidelity). In examples, this includes generating a low-poly, optimized variant suitable for the mobile AR authoring experience and preserving the high-fidelity details in a file ideal for cloud rendering or desktop editing.

The composable framework enables users to place assets (e.g., 3D models) within AR scenes by translating, rotating, and scaling the assets, as well as selecting from a range of animation behaviors. Users can then capture stills or record videos in AR. When the user's actions are reflected in the scene description, the composable framework builds a high-quality 3D scene for rendering using the detailed high fidelity asset variants. This can also enable hardware- and/or 3D engine specific software (e.g., Blender editors, etc.), to be used to edit the resultant content.

In a specific example, composables can include a virtual API-based 3D scene description system that supports composability of various 3D file formats (e.g., .gltf, .usd, .fbx, .blend, etc.). Composables can act as a custom application-specific wrapper to solve glTF composability issues. A composable can be defined by a JSON-like schema that includes metadata, asset references, and scene information, or otherwise defined.

In variants, composables can reference both 3D assets (e.g., glTF files), and other composables, creating a hierarchical structure. In variants, an override system can allow non-invasive modifications to composables, such as changing asset properties or removing assets from the tree.

Each asset can be represented using a single composable, wherein each composable supports different variants of the asset (e.g., source, no-textures, high-res, low-res, etc.) to optimize for different use cases. Alternatively, each variant can be represented using a different composable.

Each piece of content can be represented as a composable, or be represented as a combination of composables. In variants, composables can include a “resolution” section that provides a flat list of all 3D assets in the scene, making it easy for downstream applications to download and instantiate the asset tree. Composables can use content versioning to track updates and ensure consistency. Arbitrary key-value pairs can be added to categorize and sort composables and assets.

However, determining asset parameters for the asset S300 may be otherwise performed.

Generating content based on the asset parameters S400 functions to create high-fidelity renders of the scene. S400 can be performed by a rendering service executing a remote computing system, on a desktop, on a mobile device, on the same mobile device, and/or any other suitable computing system, and/or by another service. S400 can be performed: after a user finalizes the authoring session and initiates high fidelity content rendering; asynchronously with S200 and/or S300; concurrently with S200 and/or S300; and/or at any other time. S400 is preferably a one-time process per piece of content, but can alternatively be iteratively performed, repeated for changes, or performed any number of times.

The generated content can be a single frame, a timeseries of frames (e.g., video), audio, and/or any other suitable medium or format. The content is preferably in 3D (e.g., geometric), but can additionally or alternatively be 2D (e.g., an image or video). The content can be static or dynamic (e.g., a timeseries of 2D or 3D frames). The content can include only the rendered high-fidelity assets, the rendered high-fidelity assets and the scene measurements, the rendered high-fidelity assets and a scene representation (e.g., anchor points, geometry features, etc.), and/or any other suitable set of information.

The content (e.g., cinematic-level content) generated in S400 is preferably high fidelity content, but can additionally or alternatively be mid- or low-fidelity content. High fidelity content can have high resolution, high sharpness, high color accuracy, high contrast, high bitrate, low noise levels, low compression, be photorealistic, high dynamic range, high color depth, high audio quality, high rendering complexity, and/or other content parameters. The values for each content parameter can be predetermined, manually determined, or otherwise determined. For example, the content can have a resolution of 4K (e.g., 3840×2160 pixels) or higher; and have a high frame rate of 60 frames per second or higher.

Content can be generated based on the asset, the asset parameters (e.g., determined in S300), the scene information (e.g., scene measurements sampled during recording, scene geometries, etc.), the lighting information (e.g., which HDR datum is used to render different segments of each asset, ray tracing solutions for different regions of the asset, etc.), and/or any other information. High-fidelity content is preferably generated using the high-fidelity version of the asset, but can additionally or alternatively be generated using a lower fidelity version of the asset. High-fidelity content is preferably generated using high-fidelity version AV asset media (e.g., animations, soundtracks, etc.; example shown in FIG. 2), but can additionally or alternatively be generated using a lower fidelity version of the asset. The high fidelity content is preferably not generated using the lower-fidelity version of the asset used to author the content (e.g., on the mobile device), but can additionally or alternatively be generated using the lower-fidelity version (e.g., by modifying the lower-fidelity version instead of replacing the low-fidelity version with the high-fidelity version).

In variants, only the AV media segment between the start and stop timestamps is used when generating the content (e.g., other segments of the AV media are not used to generate the content).

In variants, the content can be generated by modifying the high-fidelity version of the asset (e.g., that replaced the mobile variant of the asset) based on the asset parameters (e.g., recorded pose data, animation data, color selections, texture selections, etc.), applying lighting data to the high-fidelity version of the asset (e.g., using the HDR data generated in S150, by simulating light transport determined from the LDR data or the scene measurements, using ray tracing, etc.), and optionally compositing the transformed high-fidelity assets onto a depiction of the scene. The depiction of the scene can be: real-world measurements (e.g., scene images), touched-up versions of the scene measurements, generated scenes (e.g., using a generative neural network, etc.), a rendered scene (e.g., wherein a simulated scene can be generated from the scene data, such as the scene geometries, detected objects, lighting, and color, etc.), and/or any other depiction of the scene. The camera motion and perspective can be matched using AR tracking data, and/or otherwise matched. In variants, physical-based rendering can be performed using path tracing, or otherwise performed.

The resultant content can be: stored as a video, presented on a content platform (e.g., social media, television, video-sharing platform, etc.), sent back to the mobile device, edited (e.g., by the same or different user; using another instance of all or portions of the method), composited with other content (e.g., generated using another instance of this method, provided by another source, etc.; by stitching the content together, by interleaving the content, by combining the content frame-by-frame, etc.), and/or otherwise managed.

However, generating content based on the asset parameters S400 may be otherwise performed.

The method can optionally include displaying the content over a view of the physical scene S500, which functions to allow for persistent AR experiences and iterative remote editing. S500 can be performed on the mobile application executing on a mobile device, or on another device. The content can be displayed to the same or different user as that engaging with S100-S300. S500 can occur at any time after scene initialization, when user returns to physical location, when a user selects the content, and/or at any other suitable time. In an example, S500 can include receiving a selection of the content (e.g., manual selection, automatically selecting the content based on detected scene features, the mobile device's geolocation, etc.), determining a set of content anchor points associated with the content, sampling measurements of the physical scene, identifying a set of anchor points within the physical scene, and displaying the generated content relative to the set of anchor points based on the set of content anchor points (e.g., by aligning the anchor points). An example is shown in FIGS. 7A-7I, depicting a set of high-fidelity XR assets (e.g., a robot, a diffuse red ball, and a reflective metallic ball) captured using the recording session shown in FIGURES SA-SM, using the HDR data and scene data captured using the initialization session shown in FIGS. 4A-4H, and modified using the authoring session shown in FIGS. 6A-6Q. Displaying the content over a view of the physical scene S500 can include updating the content (e.g., displayed frames of the content) based on the mobile device pose relative to the anchor points during display (e.g., positioning, rotating, scaling, and/or any suitable transformation.

The content retrieved from content storage (e.g., at the remote computing system) can include: only the rendered high-fidelity assets (e.g., high-fidelity assets pre-transformed according to the asset parameters), the high-fidelity assets and the scene reference points (e.g., anchors), the high-fidelity assets and scene data (e.g., scene images, scene measurements, etc.), and/or any other set of information. The type of content that is retrieved can be determined based on the viewing mode (e.g., high-fidelity assets and reference points retrieved when in AR mode; high-fidelity assets rendered over the scene measurements retrieved when in playback mode; etc.), and/or otherwise determined.

However, S500 may be otherwise performed.

### 6. Illustrative Examples

Example 1. A method for extended reality content generation, comprising: at a mobile device, generating low-fidelity content, comprising: sampling a set of measurements of a real world scene; rendering a mobile version of a digital asset relative to a view of the real world scene, based on the set of measurements; receiving a set of asset parameters from a user for the digital asset; modifying the rendered digital asset based on the asset parameters in real time; and sending the set of asset parameters to a remote computing system; and at the remote computing system: generating high-fidelity content based on the set of measurements, a high-fidelity version of the digital asset, and the set of asset parameters.

Example 2. The method of example 1, further comprising generating a set of high dynamic range data (HDR) from the set of measurements, wherein the mobile version of the digital asset is rendered using the set of HDR data.

Example 3. The method of example 2, wherein the set of HDR data comprise pre-convolved HDR environment maps at different levels of blur, each corresponding to a different surface roughness.

Example 4. The method of example 2, wherein the set of HDR data is generated at the remote computing system, wherein the set of HDR data is sent in real-time to the mobile device.

Example 5. The method of example 2, wherein generating the set of HDR data comprises: determining an initial set of camera parameters; sampling low dynamic range (LDR) data of the real-world scene using a camera with settings locked to the initial set of camera parameters; and generating the set of HDR data based on the LDR data.

Example 6. The method of example 5, wherein the camera settings are unlocked when rendering the mobile version of the digital asset relative to the real-world scene.

Example 7. The method of example 2, wherein rendering the digital asset using the set of HDR data comprises: determining a visual parameter of a component of the digital asset; and selecting an HDR datum from the set of HDR data based on the visual parameter and using the selected HDR datum to render the component of the digital asset.

Example 8. The method of example 1, wherein the set of asset parameters comprise asset audio-visual media.

Example 9. The method of example 8, wherein the set of asset parameters identify a segment of the asset audio-visual media to be used to generate the content.

Example 10. The method of example 8, wherein the asset audio-visual media comprise an animation.

Example 11. The method of example 9, wherein a low-fidelity version of the asset audio-visual media is displayed at the mobile device while generating the low-fidelity content, wherein a high-fidelity version of the asset audio-visual media is used to generate the high-fidelity content.

Example 12. The method of example 1, wherein the set of asset parameters are stored when a record button is selected at the mobile device.

Example 13. The method of example 1, further comprising: at the remote computing system, determining a set of modified asset parameters; at the mobile device located within the real world scene: identifying an anchor feature in the scene, based on secondary measurements of the scene; and rendering the digital asset based on the set of modified asset parameters based on a pose of the anchor feature relative to the mobile device.

Example 14. A method, comprising: determining a reference image of a region of a physical scene illuminated by a set of ambient light sources; determining a set of static optical sensor settings based on the reference image; sampling a low dynamic range (LDR) data of the scene using the set of static optical sensor settings; determining a set of high dynamic range (HDR) data of the scene based on the LDR data; and rendering a digital asset, using the HDR data, over a view of the scene.

Example 15. The method of example 14, wherein the rendered digital asset is a mobile-optimized version of the digital asset.

Example 16. The method of example 15, further comprising: determining a set of asset parameters for each of a set of assets virtually arranged within the scene; and rendering high-fidelity content based on high-fidelity versions of each of the set of assets and the respective set of asset parameters.

Example 17. The method of example 16, wherein the digital asset is associated with audio-visual media, wherein a low-fidelity version of the audio-visual media is used to render the digital asset, and wherein a high-fidelity version of the audio-visual media is used to render the high-fidelity content.

Example 18. The method of example 14, wherein different components of the digital asset are contemporaneously rendered using different HDR datum from the set of HDR data, selected based on visual properties assigned to the respective component.

Example 19. The method of example 14, wherein a mobile device determines the reference image, determines set of static optical sensor settings, samples the LDR data, and renders the digital asset, wherein a remote computing system determines the set of HDR data, wherein the mobile device sends the LDR data to the revive computing system and receives the set of HDR data from the remote computing system.

Example 20. The method of example 14, wherein the LDR data is sampled by a mobile device; wherein the set of HDR data is generated from the LDR data at a remote computing system, comprising: predicting an HDR environment map using a machine learning model; and convolving the HDR environment map to generate a set of pre-convolved HDR maps, wherein the set of HDR data comprise the set of pre-convolved HDR maps, wherein the pre-convolved HDR maps are transmitted to the mobile device, wherein rendering a digital asset using the set of HDR data comprises, at the mobile device, sampling a pre-convolved HDR map from the set of pre-convolved HDR maps based on a surface property of the digital asset.

Example 21. The method of example 14, wherein the region of the scene is a floor of the scene.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

1. A method for extended reality content generation, comprising:
at a mobile device, generating low-fidelity content, comprising:
sampling a set of measurements of a real world scene;
rendering a mobile version of a digital asset relative to a view of the real world scene, based on the set of measurements;
receiving a set of asset parameters from a user for the digital asset;
modifying the rendered digital asset based on the asset parameters in real time; and
sending the set of asset parameters to a remote computing system; and
at the remote computing system:
generating high-fidelity content based on the set of measurements, a high-fidelity version of the digital asset, and the set of asset parameters.

2. The method of claim 1, further comprising generating a set of high dynamic range data (HD R data) from the set of measurements, wherein the mobile version of the digital asset is rendered using the set of HDR data.

3. The method of claim 2, wherein the set of IDR data comprise pre-convolved HDR environment maps with different levels of blur, each associated with a different surface roughness.

4. The method of claim 2, wherein the set of HDR data is generated at the remote computing system, wherein the set of HDR data is sent in real-time to the mobile device.

5. The method of claim 2, wherein generating the set of HDR data comprises:
determining an initial set of camera parameters;
sampling low dynamic range (LDR) data of the real-world scene using a camera with settings locked to the initial set of camera parameters; and
generating the set of HDR data based on the LDR data.

6. The method of claim 5, wherein the camera settings are unlocked when rendering the mobile version of the digital asset relative to the real-world scene.

7. The method of claim 2, wherein rendering the digital asset using the set of HDR data comprises:
determining a visual parameter of a component of the digital asset; and
selecting an HDR datum from the set of HDR datum based on the visual parameter and using the selected HDR datum to render the component of the digital asset.

8. The method of claim 1, wherein the set of asset parameters comprise asset audio-visual media.

9. The method of claim 8, wherein the set of asset parameters identify a segment of the asset audio-visual media to be used to generate the content.

10. The method of claim 8, wherein the asset audio-visual media comprise an animation.

11. The method of claim 9, wherein a low-fidelity version of the asset audio-visual media is displayed at the mobile device while generating the low-fidelity content, wherein a high-fidelity version of the asset audio-visual media is used to generate the high-fidelity content.

12. The method of claim 1, wherein the set of asset parameters are stored when a record button is selected at the mobile device.

13. The method of claim 1, further comprising:
at the remote computing system, determining a set of modified asset parameters;
at the mobile device located within the real world scene:
identifying an anchor feature in the scene, based on secondary measurements of the scene; and
rendering the digital asset based on the set of modified asset parameters based on a pose of the anchor feature relative to the mobile device.

14. A method, comprising:
determining a reference image of a region of a physical scene illuminated by a set of ambient light sources;
determining a set of static optical sensor settings based on the reference image;
sampling low dynamic range (LDR) data of the scene using the set of static optical sensor settings;
determining a set of high dynamic range (HDR) data of the scene based on the LDR data; and
rendering a digital asset, using the set of HDR data, over a view of the scene.

15. The method of claim 14, wherein the rendered digital asset is a mobile-optimized version of the digital asset.

16. The method of claim 15, further comprising:
determining a set of asset parameters for each of a set of assets virtually arranged within the scene; and
rendering high-fidelity content based on high-fidelity versions of each of the set of assets and the respective set of asset parameters.

17. The method of claim 16, wherein the digital asset is associated with audio-visual media, wherein a low-fidelity version of the audio-visual media is used to render the digital asset, and wherein a high-fidelity version of the audio-visual media is used to render the high-fidelity content.

18. The method of claim 14, wherein different components of the digital asset are contemporaneously rendered using the set of iiDR data from the set of HDR data, selected based on surface properties assigned to the respective component.

19. The method of claim 14, wherein:
a mobile device determines the reference image, determines set of static optical sensor settings, samples the LDR data, and renders the digital asset;
wherein the mobile device sends the LDR data to a remote computing system, wherein the remote computing system determines a set of HDR data, each associated with a visual property; and
wherein the mobile device receives the set of HDR data and selectively renders a component of the asset using an HDR datum from the set associated with a visual property of the component.

20. The method of claim 14, wherein the LDR data is sampled by a mobile device; wherein the set of HDR data is generated from the LDR data at a remote computing system, comprising:
predicting an HDR environment map using a machine learning model; and
convolving the HDR environment map to generate a set of pre-convolved HDR maps, wherein the set of JHDR data comprise the set of pre-convolved HDR maps, wherein the pre-convolved HDR maps are transmitted to the mobile device, wherein rendering a digital asset using the set of HDR data comprises, at the mobile device, sampling a pre-convolved HDR map from the set of pre-convolved HDR maps based on a surface property of the digital asset.
